(19) United States
(12) Patent Application Publication
(10) Pub. No.: US 2025/0224544 A1
(43) Pub. Date: Jul. 10, 2025

(54) LENS, IMAGING DEVICE, AND LIGHT EMITTING DEVICE

(71) Applicant: SONY GROUP CORPORATION, Tokyo (JP)

(72) Inventors: Hiroyuki TAHARA, Tokyo (JP); Toshifumi YASUI, Tokyo (JP)

(73) Assignee: SONY GROUP CORPORATION, Tokyo (JP)

(21) Appl. No.: 18/846,763

(22) PCT Filed: Mar. 14, 2023
(86) PCT No.: PCT/JP2023/009882

§ 371 Date: Sep. 13, 2024

(30) Foreign Application Priority Data
Mar. 31, 2022 (JP) 2022-058754

(51) Int. Cl. G02B 3/08

(52) U.S. Cl. CPC G02B 3/08

(57) ABSTRACT

The present technology relates to a lens, an imaging device, and a light emitting device that enable achievement of isotropy of optical characteristics and a high diffraction efficiency in a peripheral region at a distance from the optical center of the lens. A metalens includes: a center region located in a central portion; and a plurality of ring-shaped peripheral regions located around the center region. In the metalens, a pattern in the peripheral regions has constant intervals in an angular direction, an angular interval Δθₖ:Δθₖ₊₁ is an integer ratio Mₖ:Mₖ₊₁, where Δθₖ represents an angular interval in the k-th peripheral region from the inner side among the peripheral regions, and Δθₖ₊₁ represents an angular interval in the (k+1)-th peripheral region from the inner side, the (k+1)-th peripheral region being adjacent to the k-th peripheral region, and the Mₖ₊₁ is an integer smaller than 10.

### TECHNICAL FIELD

The present technology relates to a lens, an imaging device, and a light emitting device, and more particularly, to a lens, an imaging device, and a light emitting device that are capable of achieving isotropy of optical characteristics and a high diffraction efficiency in a peripheral region that is a region at a distance from the optical center of the lens.

### BACKGROUND ART

A bulk lens achieves a desired lens function by refracting incident light in accordance with a thickness distribution at an interface and emitting the light at a desired emission angle based on the Snell's law. In recent years, as novel lenses, metalenses in which microstructures of a spatial scale equal to or smaller than the wavelength of light are formed on a flat surface have been researched and developed. A metalens achieve a desired lens function by modulating the phase of incident light with its microstructures and emitting outgoing light having a desired phase distribution.

The microstructures of such a metalens are formed by arranging a plurality of pillars. As a method of arranging the pillars, there is a layout method for arranging pillars on a lattice on the basis of the position coordinates of the orthogonal coordinate system of the metalens. However, since the microstructures in which pillars are arranged by this layout method are anisotropic, it is difficult to ensure isotropy of the optical characteristics of the metalens.

On the other hand, as a method for arranging pillars, there also is a layout method for arranging pillars concentrically at constant angular intervals on the basis of the position coordinates of the polar coordinate system of the metalens (see Patent Document 1, for example). As the microstructures in which pillars are arranged by this layout method is isotropic, isotropy of the optical characteristics of the metalens can be ensured.

However, in a case where pillars are arranged at constant angular intervals, regardless of the distance from the optical center of the lens, the pillar placement intervals are more sparse at a longer distance in the circumferential direction from the optical center of the lens. Therefore, it is difficult to modulate the phase in a peripheral region that is a region at a distance from the optical center of the lens, and diffraction efficiency drops. In view of this, it is conceivable to increase the diffraction efficiency by shortening the angular intervals at a longer distance from the optical center of the lens.

### CITATION LIST

### Patent Document

Patent Document 1: U.S. Patent Application Publication No. 2020/0174163

### SUMMARY OF THE INVENTION

### Problems to be Solved by the Invention

However, in a case where the angular intervals are shorter at a longer distance from the optical center of the lens, isotropy may be broken near a boundary at which the angular intervals change.

Therefore, there is a demand for providing a technique for achieving isotropy of optical characteristics and a high diffraction efficiency in a peripheral region, but such a demand is not sufficiently met in the current circumstances.

The present technology has been made in view of such circumstances, and aims to achieve isotropy of optical characteristics and a high diffraction efficiency in a peripheral region that is a region at a distance from the optical center of a lens.

### Solutions to Problems

A lens according to a first aspect of the present technology is a lens that includes: a center region located in a central portion; and a plurality of ring-shaped peripheral regions located around the center region. In the lens, a pattern in the peripheral regions has constant intervals in an angular direction, an angular interval Δθₖ:Δθₖ₊₁ is an integer ratio Mₖ:Mₖ₊₁, where Δθₖ represents an angular interval in the k-th peripheral region from an inner side among the peripheral regions, and Δθₖ₊₁ represents an angular interval in the (k+1)-th peripheral region from the inner side, the (k+1)-th peripheral region being adjacent to the k-th peripheral region, and the Mₖ₊₁ is an integer smaller than 10.

In the first aspect of the present technology, a center region located in a central portion, and a plurality of ring-shaped peripheral regions located around the center region are provided. A pattern in the peripheral regions has constant intervals in an angular direction, an angular interval Δθₖ:Δθₖ₊₁ is an integer ratio Mₖ:Mₖ₊₁, where Δθₖ represents an angular interval in the k-th peripheral region from the inner side among the peripheral regions, and Δθₖ₊₁ represents an angular interval in the (k+1)-th peripheral region from the inner side, the (k+1)-th peripheral region being adjacent to the k-th peripheral region, and the Mₖ₊₁ is an integer smaller than 10.

An imaging device according to a second aspect of the present technology includes: a lens including: a center region located in a central portion; and a plurality of ring-shaped peripheral regions located around the center region, in which a pattern in the peripheral regions has constant intervals in an angular direction, an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and the Mₖ₊₁ is an integer smaller than 10; and an imaging element that receives light via the lens.

In the second aspect of the present technology, a lens and an imaging element are provided. The lens includes: a center region located in a central portion; and a plurality of ring-shaped peripheral regions located around the center region, in which a pattern in the peripheral regions has constant intervals in an angular direction, an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and the Mₖ₊₁ is an integer smaller than 10. The imaging element receives light via the lens.

A light emitting device according to a third aspect of the present technology includes: a lens including: a center region located in a central portion; and a plurality of ring-shaped peripheral regions located around the center region, in which a pattern in the peripheral regions has constant intervals in an angular direction, an angular interval Δθₖ:Δθₖ₊₁ is an integer ratio Mₖ:Mₖ₊₁, where Δθₖ represents an angular interval in the k-th peripheral region from the inner side among the peripheral regions, and Δθₖ₊₁ represents an angular interval in the (k+1)-th peripheral region from the inner side, the (k+1)-th peripheral region being adjacent to the k-th peripheral region, and the Mₖ₊₁ is an integer smaller than 10; and a light emitting element that emits light that enters the lens.

In the third aspect of the present technology, a lens and an imaging element are provided. The lens includes: a circular center region located in a central portion; and a plurality of ring-shaped peripheral regions located around the center region, in which a pattern in the peripheral regions has constant intervals in an angular direction, an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and the Mₖ₊₁ is an integer smaller than 10. The imaging element receives light via the lens.

A lens according to a fourth aspect of the present technology is a lens that includes: a first peripheral region that is an annular region centered around an optical center, and is divided into N1 first periodic regions at each center angle θ1; a second peripheral region that is located on the outer side of the first peripheral region, is an annular region centered around the optical center, and is divided into N2 second periodic regions at each center angle θ2; and a circular center region that is located on the inner side of the first peripheral region, and is centered around the optical center. In the lens, a pattern is provided in the first periodic regions and the second periodic regions, on the basis of position coordinates in a polar coordinate system, the center angle θ1 is greater than the center angle θ2, the center region has four or more central symmetry axes that are symmetry axes for the pattern, the pattern in the center region is symmetric about the central symmetry axes, and the layout of the pattern in the center region is an orthogonal coordinate layout.

In the fourth aspect of the present technology, a first peripheral region, a second peripheral region, and a circular center region are provided. The first peripheral region is an annular region centered around an optical center, and is divided into N1 first periodic regions at each center angle θ1. The second peripheral region is located on the outer side of the first peripheral region, is an annular region centered around the optical center, and is divided into N2 second periodic regions at each center angle θ2. The circular center region is located on the inner side of the first peripheral region, and is centered around the optical center. A pattern is provided in the first periodic regions and the second periodic regions, on the basis of position coordinates in a polar coordinate system. The center angle θ1 is greater than the center angle θ2. The center region has four or more central symmetry axes that are symmetry axes for the pattern. The pattern in the center region is symmetric about the central symmetry axes. The layout of the pattern in the center region is an orthogonal coordinate layout.

### BRIEF DESCRIPTION OF DRAWINGS

FIG. 1 is a cross-sectional view illustrating an example configuration of a distance measuring device including a first embodiment of a metalens to which the present technology is applied.

FIG. 2 is a cross-sectional view illustrating a first example configuration of the metalens illustrated in FIG. 1.

FIG. 3 is a top view of the metalens, illustrating an example layout of pillars.

FIG. 4 is an enlarged view of a rectangle shown in FIG. 3.

FIG. 5 is a diagram illustrating the position of each pillar of a metalens in which pillars are arranged in an orthogonal coordinate layout as a whole.

FIG. 6 is a top view of a metalens in which pillars are arranged in an orthogonal coordinate layout as a whole.

FIG. 7 is a diagram illustrating an example of the characteristics of the metalens illustrated in FIG. 6.

FIG. 8 is graphs illustrating results of simulations performed on metalenses.

FIG. 9 is a diagram illustrating a metalens in which pillars are arranged in polar coordinates at constant angular intervals as a whole.

FIG. 10 is a top view of a metalens in which the ratio between the center angles of two adjacent peripheral regions is not an integer ratio.

FIG. 11 is a diagram for explaining local angular intervals in the vicinity of a boundary.

FIG. 12 is a diagram for explaining the specification of a lens system.

FIG. 13 is diagrams for explaining phases to be modulated by pillars.

FIG. 14 is side views of a metalens.

FIG. 15 is a diagram for specifically explaining a method for optimizing the pattern of pillars in a periodic region.

FIG. 16 is another diagram for specifically explaining a method for optimizing the pattern of pillars in a periodic region.

FIG. 17 is a diagram for explaining optimization for the unit regions other than the innermost unit region in a unit group.

FIG. 18 is a diagram for explaining a periodic boundary condition imposed on each side of a unit region.

FIG. 19 is a diagram illustrating another example of the pattern of pillars in a periodic region.

FIG. 20 is a diagram illustrating yet another example of the pattern of pillars in a periodic region.

FIG. 21 is a diagram illustrating a first example of the condition for the number of pattern switching positions among pillars.

FIG. 22 is a diagram illustrating an example of a method of expressing a pattern of pillars.

FIG. 23 is a diagram illustrating a second example of the condition for the number of pattern switching positions among pillars.

FIG. 24 is top views of the center region, illustrating examples of the patterns of pillars in the center region.

FIG. 25 is a graph illustrating the relationship between the radius of pillars and the phase amount to be modulated by the pillars.

FIG. 26 is a graph illustrating phase distributions.

FIG. 27 is part of a top view of a metalens, illustrating a second example configuration of a metalens.

FIG. 28 is a diagram for explaining details of patterns of pillars in a periodic region.

FIG. 29 is a diagram for explaining details of patterns of pillars in a periodic region.

FIG. 30 is a diagram for explaining details of patterns of pillars in a periodic region.

FIG. 31 is a perspective view illustrating an example of the external configuration of a rectangular parallelepiped pillar shown in FIG. 30.

FIG. 32 is part of a top view of a second embodiment of a metalens to which the present technology is applied.

FIG. 33 is an enlarged view of a rectangle shown in FIG. 32.

FIG. 34 is diagrams illustrating examples of center regions in which pillars are arranged in an orthogonal coordinate layout.

FIG. 35 is diagrams illustrating examples of center regions having four, six, and eight symmetry axes.

FIG. 36 is diagrams illustrating other examples of center regions having four, six, and eight symmetry axes.

FIG. 37 is diagrams illustrating other examples of metalenses.

### MODE FOR CARRYING OUT THE INVENTION

In the description below, modes for carrying out the present technology (these modes will be hereinafter referred to as embodiments) are described. Note that explanation will be made in the following order.
1. First embodiment (a metalens in which pillars are disposed)
2. Second embodiment (a metalens in which free-form patterns are arranged)

Note that the same or similar portions are denoted by the same or similar reference signs in the drawings referred to in the following description. However, the drawings are schematic, and the relationship between the thickness and the plane dimension, the ratio of the thickness of each layer, and the like are different from the actual ones. Further, the drawings include portions having dimensional relationships and ratios that vary among the drawings in some cases.

Furthermore, the definitions of directions such as upward and downward directions and the like in the following description are merely definitions for ease of explanation, and do not limit the technical idea of the present disclosure. For example, when an object is rotated by 90° to be observed, the upper and lower sides are changed as the left and right sides, and when the object is rotated by 180°, the upper and lower sides are reversed.

### First Embodiment

### <Example Configuration of a Distance Measuring Device>

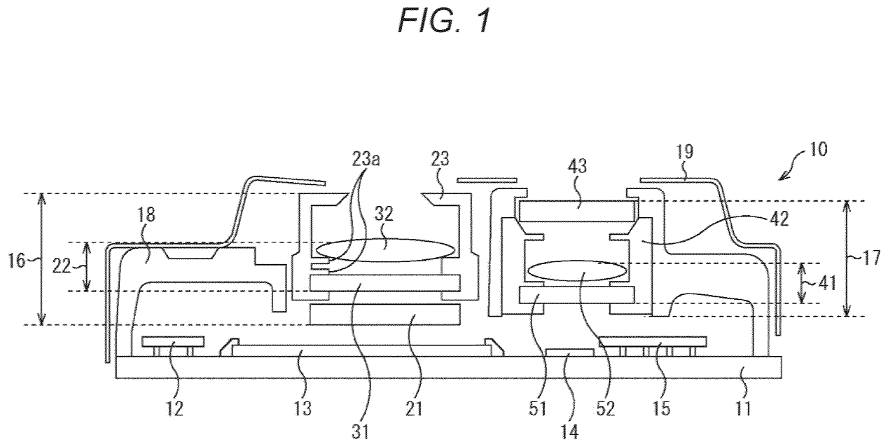

FIG. 1 is a cross-sectional view illustrating an example configuration of a distance measuring device including a first embodiment of a metalens to which the present technology is applied.

A distance measuring device 10 in FIG. 1 is a light detection and ranging (LiDAR) module that measures distance with laser light by a time of flight (TOF) method among LiDAR distance measuring methods.

Specifically, in the distance measuring device 10, a memory 12, a complementary metal oxide semiconductor (CMOS) image sensor 13, a vertical cavity surface emitting laser (VCSEL) 14, and a VCSEL driver 15 are disposed on a surface of a substrate 11. A resin case 18 for securing optical systems 16 and 17 is provided on the substrate 11 so that the optical system 16 on the light receiving side is disposed on the CMOS image sensor 13, and the optical system 17 on the light projecting side is disposed on the VCSEL 14. The substrate 11 on which the case 18 is disposed is covered with a metallic case 19.

The substrate 11 is a ceramic substrate, for example. The optical system 16 on the light receiving side includes a filter 21 on the side of the substrate 11 (the lower side in FIG. 1), and a lens system 22 and a columnar support member 23 that supports the lens system 22 on the light entering side (the upper side in FIG. 1). The lens system 22 includes a metalens 31 on the side of the substrate 11, and a bulk lens 32 on the light entering side. The metalens 31 and the bulk lens 32 are each secured by a plastic spacer 23a provided on the support member 23.

The optical system 17 on the light projecting side includes a lens system 41 and a columnar support member 42 that supports the lens system 41 on the side of the substrate 11, and includes a diffractive optical element (DOE) 43 on the light emitting side (the upper side in FIG. 1). The lens system 41 includes a metalens 51 on the side of the substrate 11, and a bulk lens 52 on the light emitting side. Like the support member 23, the support member 42 may be provided with a spacer that secures the metalens 51 and the bulk lens 52.

In the distance measuring device 10 designed as described above, the VCSEL 14 as a light emitting element emits laser light, and the laser light enters the optical system 17 and is emitted toward the distance measurement target. In this manner, the distance measuring device 10 functions as a light emitting device. The laser light emitted toward the distance measurement target is reflected by the distance measurement target, and is received by the CMOS image sensor 13 as an imaging element via the optical system 16. The CMOS image sensor 13 performs imaging by converting the received light into an electric signal, and the electric signal is held in the memory 12. In this manner, the distance measuring device 10 also functions as an imaging device. The distance measuring device 10 measures distance by detecting the flight time of light until the laser light emitted from the VCSEL 14 is reflected by the distance measurement target and returns, on the basis of the electric signal held in the memory 12.

Since the lens system 22 on the light receiving side includes the metalens 31, instead of a bulk lens, it is possible to realize enlargement of the field of view (FoV), a reduction of the f-number (an increase in brightness), an increased contrast, an enhanced uniformity, a reduction of flare, miniaturization (a reduction in height) and a weight reduction of the distance measuring device 10, and the like. Since the lens system 41 on the light projecting side includes the metalens 51, instead of a bulk lens, it is possible to realize enlargement of the laser light irradiation region (enlargement of the distance measurement range), miniaturization (a reduction in height), a reduction in weight, and the like of the distance measuring device 10.

In the description below, a case where the present technology is applied to the metalens 31 will be described. However, the present technology can be applied to the metalens 51 in a similar manner.

### <First Example Configuration of a Metalens>

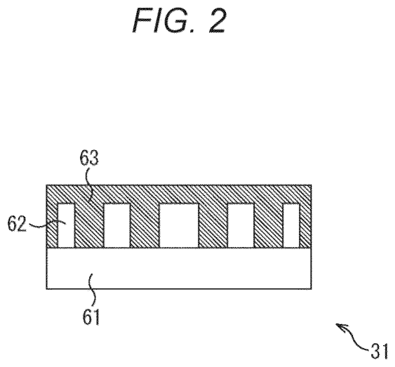

FIG. 2 is a cross-sectional view illustrating a first example configuration of the metalens 31 in FIG. 1.

As illustrated in FIG. 2, the metalens 31 is a metasurface formed by disposing pillars 62 on a surface of a substrate 61, and filling the spaces between the pillars 62 with an embedding layer 63. To simplify the drawing, only five pillars 62 are illustrated in FIG. 2. However, a large number of pillars 62 are actually provided.

As the substrate 61, a material for a general semiconductor device, such as Si single crystal, quartz, Pyrex (registered trademark), or a compound semiconductor GaAs, SiC, or the like is used. The thickness of the substrate 61 is several hundreds of μm, for example. The pillars 62 are formed with TiO₂, p-Si, or the like, and have a higher refractive index than the embedding layer 63. The horizontal size (the size as viewed from above) of the pillars 62 is smaller than both the wavelength of incident light in the substrate 61 and the wavelength of incident light in the embedding layer 63. For example, in a case where the metalens 31 is a metalens designed for incident light having a wavelength of 2000 nm in vacuum, the refractive indexes of the substrate 61 and the embedding layer 63 are higher than 1, and therefore, the size of the pillars 62 in the horizontal direction is 2000 nm or smaller. The pillars 62 are artificial optical resonators called meta-atoms. The shape and the size of the pillars 62 can vary with each pillar 62. Examples of the shape of the pillars 62 include a column, an elliptic column, a rectangular parallelepiped, a cube, and the like that can be expressed only by a simple figure. Note that an antireflection film may be formed on the embedding layer 63.

The metalens 31 designed as described above modulates the phase of incident light with the pillars 62. That is, the metalens 31 imparts, through the pillars 62, a phase depending on the shape and the size of the pillars 62 to the incident light. Note that the metasurface layer is not a single layer, but a plurality of layers may be stacked. Metasurface layers may be formed on both surfaces of the substrate 61. In a case where the metasurface layer is a multilayer, the present invention is only required to be applied to at least one layer, and the present invention may or may not be applied to the other layers.

### <Example Layout of the Pillars>

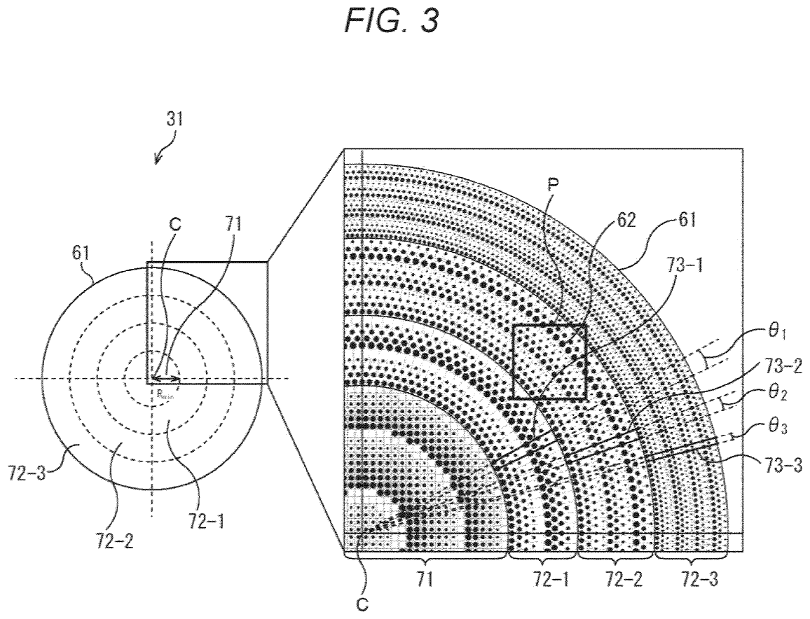

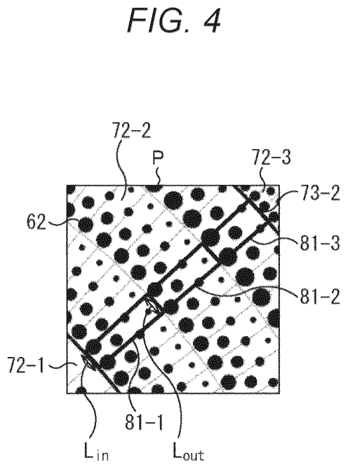

FIG. 3 is a top view of the metalens 31, illustrating an example layout of the pillars 62. FIG. 4 is an enlarged view of a rectangle P shown in FIG. 3.

A circular center region 71 that centers around an optical center C and has a predetermined radius Rₘᵢₙ (several tens of μm to several hundreds of μm, for example), and three annular (ring-like) peripheral regions 72-1 to 72-3 that center around the optical center C are formed on the substrate 61 of the metalens 31 in FIG. 3.

The center region 71 is disposed in the central portion of the metalens 31, which is on the inner side of the peripheral regions 72-1 to 72-3. In the center region 71, a plurality of pillars 62 is arranged on a square lattice, on the basis of position coordinates in an orthogonal coordinate system. Note that the pillars 62 disposed in the center region 71 may be arranged not on a square lattice but on some other regular polygonal lattice such as a regular hexagonal lattice. Such a layout on a regular polygonal lattice will be hereinafter referred to as an orthogonal coordinate layout.

In the center region 71, four symmetry axes (central symmetry axes) are provided at intervals of 45 degrees around the optical center C. The pattern of the pillars 62 disposed in the center region 71 is symmetric about each symmetry axis. In the center region 71, a free-form structure that has a shape difficult to express only with simple figures and has a higher refractive index than that of the embedding layer 63 may be disposed, instead of the pillars 62. In the present specification, the pillars 62 that can be expressed only with simple figures, and a free-form structure are also collectively referred to as a pattern. The number of symmetry axes provided in the center region 71 is only required to be four or more, and may be six, for example.

The peripheral regions 72-1 to 72-3 are disposed adjacent to the center region 71 in the order of the peripheral regions 72-1, 72-2, and 72-3 from the inner side. Note that, in the description below, in a case where there is no particular need to distinguish the peripheral regions 72-1 to 72-3 from one another, they will be collectively referred to as the peripheral regions 72.

In the peripheral regions 72, a plurality of pillars 62 is concentrically arranged at angular intervals corresponding to the distance from the optical center C, on the basis of the position coordinates in a polar coordinate system. Specifically, a peripheral region 72-i (i=1, 2, or 3) is divided into Nᵢ periodic regions 73-i at each center angle θᵢ. In each periodic region 73-i, the pillars 62 are disposed on the basis of the position coordinates in the polar coordinate system, and the pattern (configuration) of the pillars 62 disposed in each periodic region 73-i is the same. Accordingly, the pattern of the pillars 62 in each peripheral region 72-i has periodicity at intervals of the center angle θᵢ in the angular direction. Note that the pattern of the pillars 62 is the number of the pillars 62, and the position, shape, and size of each pillar 62.

The center angle θᵢ of the peripheral region 72-i (first peripheral region) is greater than the center angle θⱼ of the peripheral region 72-j (j>i) (second peripheral region) disposed on the outer side of the peripheral region 72-i. That is, the number Nᵢ of the periodic regions 73-i in the peripheral region 72-i (first peripheral region) is smaller than the number Nⱼ of periodic regions 73-j in the peripheral region 72-j disposed on the outer side of the peripheral region 72-i.

For example, the center angle θ₁ of the periodic region 73-1 is greater than the center angle θ₂ of the periodic region 73-2 and the center angle θ₃ of the periodic region 73-3 disposed on the outer side of the periodic region 73-1. The center angle θ₂ of the periodic region 73-2 is greater than the center angle θ₃ of the periodic region 73-3 disposed on the outer side of the periodic region 73-2. Note that, in the description below, in a case where there is no particular need to distinguish the periodic regions 73-1 to 73-3 from one another, they will be collectively referred to as the periodic regions 73. The concentric layout based on the position coordinates of the polar coordinate system is referred to as a polar coordinate layout.

The ratio between the center angles θᵢ and θᵢ₊₁ of two adjacent peripheral regions 72 is set so that Mᵢ₊₁ is a positive integer that is smaller than 10, where the ratio is expressed as an integer ratio Mᵢ:Mᵢ₊₁, using disjoint positive integers (positive integers with which the greatest common divisor is 1) Mᵢ and Mᵢ₊₁. Since θᵢ is expressed as θᵢ [deg]=360/Nᵢ, the center angle ratio θᵢ:θᵢ₊₁=360/Nᵢ: 360/Nᵢ₊₁=Nᵢ₊₁:Nᵢ, and the center angle ratio θᵢ:θᵢ₊₁ is always an integer ratio. In the example in FIG. 3, the center angle θ₁: the center angle θ₂=3:2, and the center angle θ₂: the center angle θ₃=2:1.

As illustrated in FIG. 4, the periodic region 73-2 is divided into unit regions 81-1 to 81-p (p being an integer of 1 or greater) corresponding to the range in which the phase distribution of the metalens 31 changes by 2π in the radial direction. In FIG. 4, p is set to three to simplify the drawing, but p is not limited to this. Note that, in the description below, in a case where there is no particular need to distinguish the unit regions 81-1 to 81-p from one another, they will be collectively referred to as the unit regions 81.

The patterns of the pillars 62 in a pair of adjacent unit regions 81 in the periodic region 73-2 are basically similar. For example, the type of the shape of the pillars 62 in a pair of adjacent unit regions 81, and the numbers of pillars 62 in the respective shapes are basically equal, and the positions and sizes of the pillars 62 are similar. Although only the periodic region 73-2 has been described with reference to FIG. 4, the periodic regions 73 other than the periodic region 73-2 are also divided into unit regions in a similar manner, and the patterns of the pillars 62 in a pair of adjacent unit regions basically have similarity. In the description below, in a case where there is no need to distinguish the unit regions in the respective periodic regions 73 other than the periodic region 73-2 from one another, they will be collectively referred to as the unit regions 81.

Note that, when the metalens 31 is designed, the pattern of the pillars 62 is optimized in each unit region 81, as described later. In a case where an electromagnetic field analysis technique such as an existing rigorous coupled-wave analysis (RCWA) is used in this optimization, the shape of the unit regions 81 needs to approximate a rectangle. Therefore, to reduce degradation of optical characteristics due to an error between the shape of the unit regions 81 assumed at the time of optimization and the actual shape of the unit regions 81, the start position of the peripheral region 72-1 in the radial direction needs to be set at such a position that the difference between the inner circumferential length Lᵢₙ and the outer circumferential length Lₒᵤₜ of each unit region 81 does not become too large. That is, it is necessary to set the radius Rₘᵢₙ of the center region 71 in FIG. 3 so that the ratio of the inner circumferential length Lᵢₙ to the outer circumferential length Lₒᵤₜ of the unit regions 81 is higher than a predetermined ratio.

For example, in a case where the ratio is 80%, the ratio of the unit region 81-1 is Rₘᵢₙ/(Rₘᵢₙ+ΔR)>0.8, where the radius of the center region 71 is Rₘᵢₙ as illustrated in FIG. 3, and the radial length of the innermost unit region 81-1 in the peripheral region 72-1 is ΔR. In general, the phase distribution of the metalens 31 is steeper at an outer portion, and the length of each unit region 81 in the radial direction is smaller at an outer portion. Therefore, in a case where the above expression Rₘᵢₙ/(Rₘᵢₙ+ΔR)>0.8 is satisfied, the ratios of the unit regions 81 other than the innermost unit region 81-1 in the peripheral region 72-1 are higher than 80%. Therefore, the center region 71 and the peripheral region 72-1 are set so that the radius Rₘᵢₙ of the center region 71 is greater than 4ΔR.

### <Description of Effects of Pillar Layouts>

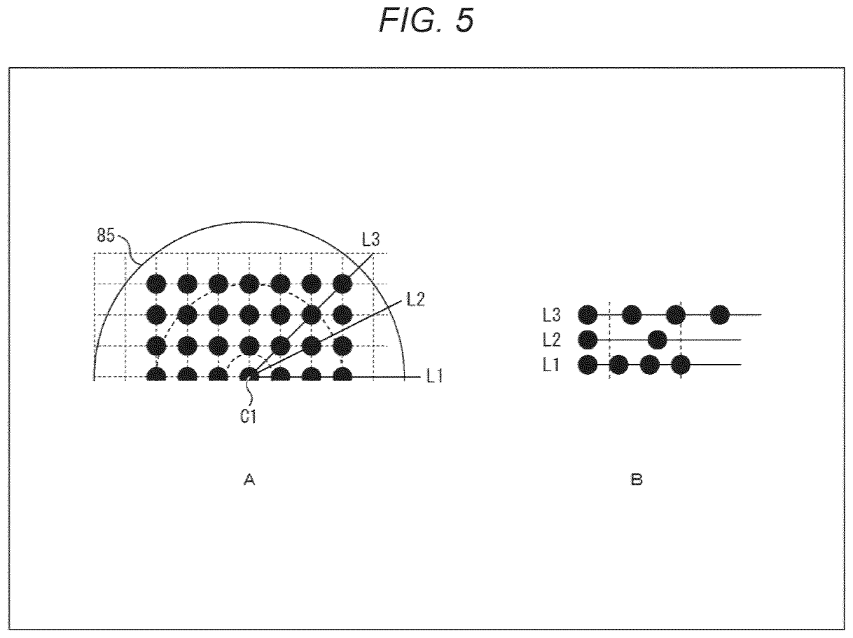

Referring to FIGS. 5 to 11, the effects of layouts of the pillars 62 in the metalens 31 are described.

First, referring to FIGS. 5 to 8, a case where pillars are arranged in orthogonal coordinates in an entire metalens is described.

A of FIG. 5 is a top view of a metalens 85, in which the positions of pillars on the metalens 85 in this case are indicated by black circles. B of FIG. 5 is a diagram in which the positions of the pillars on axes L1 to L3 shown in A of FIG. 5 are indicated by black circles, the abscissa axis being the distance from the optical center C1 of the metalens 85.

As illustrated in A of FIG. 5 and B of FIG. 5, in a case where the pillars are arranged in orthogonal coordinates, the number of pillars arranged on the axes L1 to L3 extending in different directions from the optical center C1 of the metalens 85, and the intervals between the pillars are different. That is, the symmetry of the pillars is not ensured among the axes L1 to L3.

As described above, in a case where the pillars are arranged in orthogonal coordinates, the structure of the metalens 85 is anisotropic, and it is difficult for the metalens 85 to ensure the isotropy of the optical characteristics.

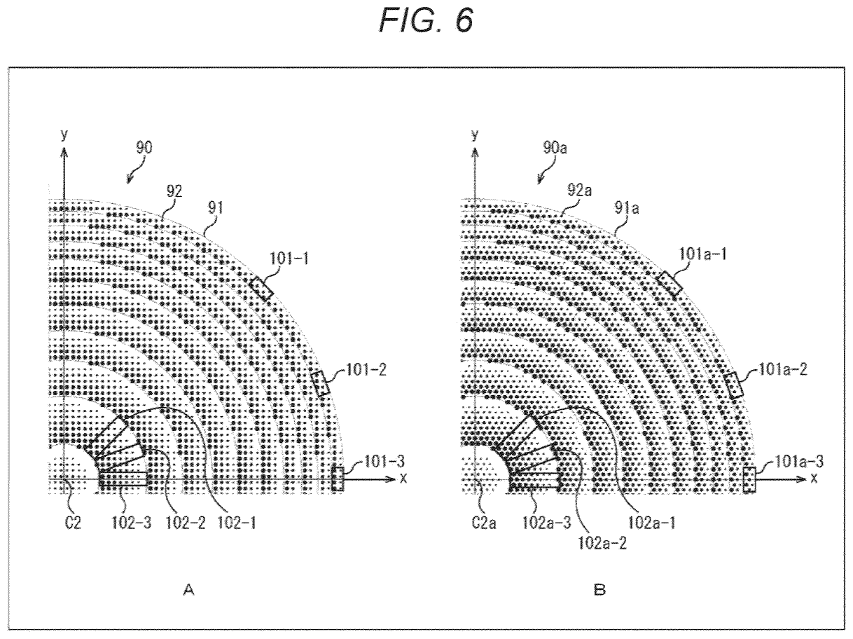

FIG. 6 is a top view of a metalens in which pillars are arranged in orthogonal coordinates as a whole.

As illustrated in A of FIG. 6, in a case where pillars 92 are arranged on a square lattice of a substrate 91 of a metalens 90, the anisotropy of the pillars 92 on the substrate 91 is remarkable due to the mismatch between the phase distribution corresponding to the metalens 90 and the orthogonal coordinates.

Further, in a case where the size of the metalens 90 is at a practical level, the folding cycle of the phase (amount) of the phase distribution is short in a peripheral region away from the optical center C2 of the metalens 90, and therefore, the difference in size between the adjacent pillars 92 is large. For example, the difference in size between the adjacent pillars 92 in regions 101-1 to 101-3 farthest from the optical center C2 is larger than the difference in size between the adjacent pillars 92 in regions 102-1 to 102-3 closer to the optical center C2 than the regions 101-1 to 101-3. Accordingly, in the regions 101-1 to 101-3, the interaction between the adjacent pillars 92 is strong.

However, as the method for determining the size of the pillars 92 on the basis of the phase distribution corresponding to the metalens 90, a library method that ignores the interaction between adjacent pillars 92 is normally adopted. Therefore, the diffraction efficiency is likely to drop in peripheral regions away from the optical center C2 of the metalens 90. Further, since the differences in size between adjacent pillars 92 vary among the regions 101-1 to 101-3 located in different directions with respect to the optical center C2, the amounts of decrease in diffraction efficiency also vary.

On the other hand, it is also conceivable to adopt a method for optimizing the size of each pillar 92 by predicting the optical characteristics taking into consideration the interaction between adjacent pillars 92 with high accuracy, using an existing electromagnetic field analysis technique such as RCWA. However, the relative positional relationship between the phase folding lines of the phase distribution corresponding to the metalens 90 and the lattice points in the orthogonal coordinate layout, and the relative relationship between the gradient direction of the phase distribution and the orthogonal coordinate axial direction vary depending on directions from the optical center C2. Therefore, it is difficult to set a rectangular region that includes peripheral pillars 92 with respect to a certain pillar 92, and has a good separation (approximately two-dimensional periodicity being established) from both the viewpoint of the layout of the pillars 92 and the viewpoint of the phase distribution. Even if a novel electromagnetic field analysis technique with high flexibility in region setting is proposed in the future, in a case where the pillars 92 are arranged in orthogonal coordinates, the layout of the pillars 92 does not have isotropy, and therefore, it is difficult to optimize the size of each pillar 92, taking into consideration the interaction between adjacent pillars 92 in the entire metalens 90.

As illustrated in B of FIG. 6, in a case where pillars 92a are arranged on a regular hexagonal lattice of a substrate 91a of a metalens 90a, a problem similar to that of the metalens 90 occurs. The optical center C2a, the substrate 91a, the pillars 92a, regions 101a-1 to 101a-3, and regions 102a-1 to 102a-3 of the metalens 90a correspond to the optical center C2, the substrate 91, the pillars 92, the regions 101-1 to 101-3, and the regions 102-1 to 102-3, respectively, and therefore, a detailed explanation of them is not made herein.

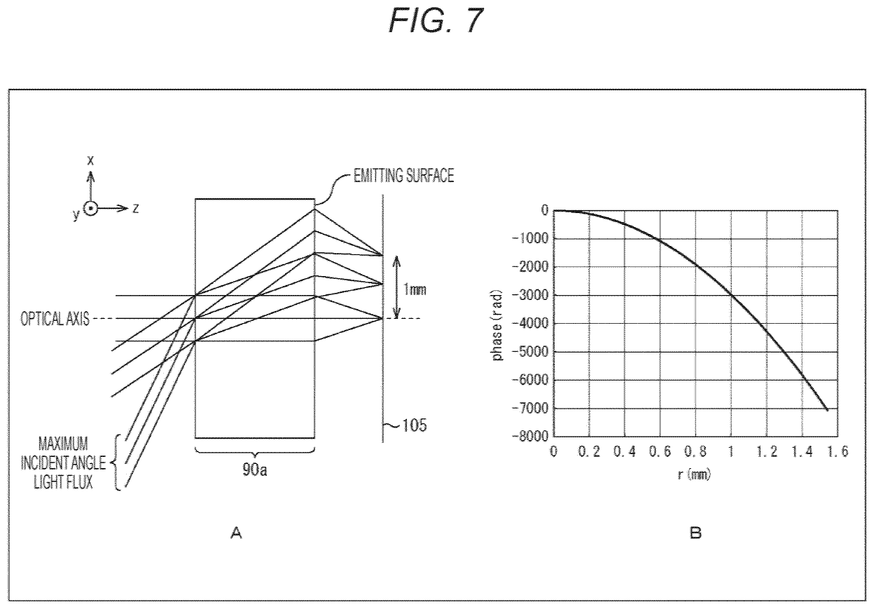

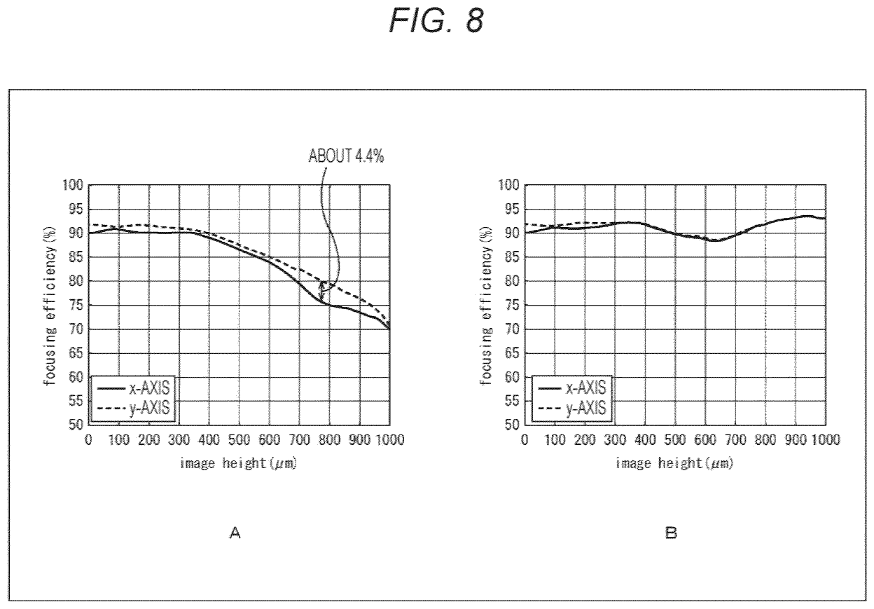

Here, as illustrated in A of FIG. 7, the phase distribution of the metalens 90a in which the operating wavelength is 940 nm, the FOV is 126°, and a maximum incident angle light flux (a light flux having an incident angle of 63°) is converged at a point where the image height (the position of a certain point in an image plane 105 is expressed as a distance from the optical axis) is 1 mm in the image plane 105 is as illustrated in B of FIG. 7. In B of FIG. 7, the abscissa axis indicates the distance from the optical axis to each point on the metalens 90a, and the ordinate axis indicates the phase. With respect to the metalens 90a in which the pillars 92a are arranged on a regular hexagonal lattice designed on the basis of the phase distribution in B of FIG. 7, a result of simulation evaluation of the focusing efficiency at each image height on the x-axis and the y-axis of the image plane 105 is as illustrated in a graph shown in A of FIG. 8. In each graph in FIG. 8, the abscissa axis indicates the image height, and the ordinate axis indicates the focusing efficiency. As illustrated in the graph in A of FIG. 8, the focusing efficiency is low in a peripheral portion of the image plane 105 strongly affected by the optical characteristics of the peripheral region of the metalens 90a, and the difference in focusing efficiency between the x-axis and the y-axis is also large. For example, in the vicinity of an image height of 760 μm, the difference in focusing efficiency between the x-axis and the y-axis is about 4.4%, which is the largest.

As described above, in a metalens in which pillars are arranged in orthogonal coordinates as a whole, the isotropy of the optical characteristics is not ensured, and the diffraction efficiency is low.

On the other hand, the graph in B of FIG. 8 indicates a result of simulation evaluation of the focusing efficiency at each image height on the x-axis and the y-axis of the image plane with respect to the metalens 31 designed on the basis of the phase distribution shown in B of FIG. 7. In B of FIG. 8, the columnar pillars 62 are arranged on a regular hexagonal lattice with a radius r<441 μm of the metalens 31, the periodic regions 73 having a pattern formed with the columnar pillars 62 with 441 μm<r<745 μm are arranged at intervals of an angle θᵢ=0.045°, and the periodic regions 73 having a pattern formed with the columnar pillars 62 with r>745 μm are arranged at intervals of an angle θᵢ=0.030°. The ratio between the angular intervals θᵢ in two adjacent peripheral regions 72 is 3:2. As illustrated in B of FIG. 8, the focusing efficiency is greatly improved on both the x-axis and the y-axis in the peripheral portion of the image plane. For example, at an image height of 1000 μm, the focusing efficiency is increased from about 70% to 93%. The difference in focusing efficiency between the x-axis and the y-axis is substantially zero.

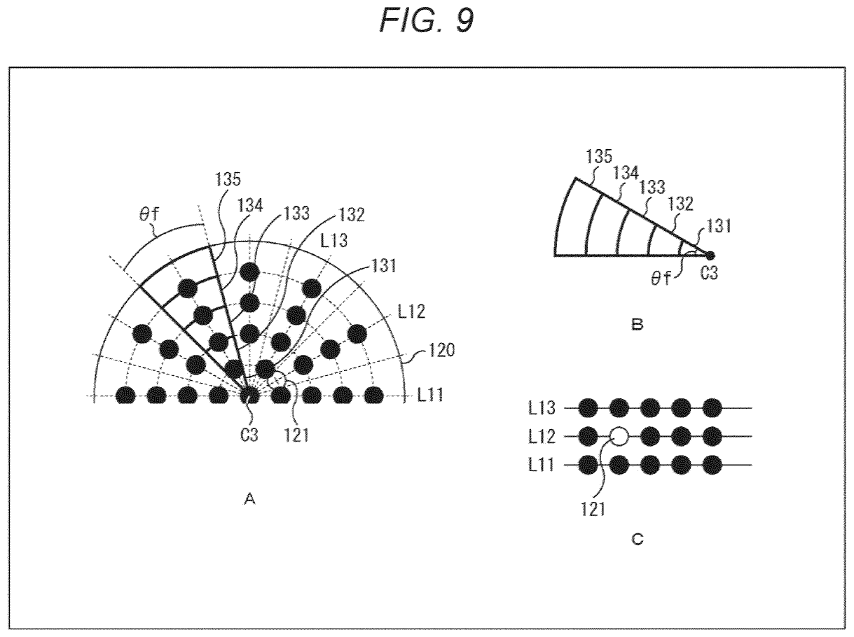

Next, referring to FIG. 9, a case where the pillars are arranged in polar coordinates at intervals of a constant angle θf in an entire metalens is described.

A of FIG. 9 is a top view of a metalens 120, in which the positions of pillars on the metalens 120 in this case are indicated by black circles. B of FIG. 9 is a top view illustrating a region in which the center angle of the metalens 120 is the angle θf. C of FIG. 9 is a diagram in which the positions of the pillars on axes L11 to L13 shown in A of FIG. 9 are indicated by black circles, the abscissa axis being the distance from the optical center C3 of the metalens 120.

In a case where pillars are arranged in polar coordinates, the numbers of pillars arranged on the axes L11 to L13 extending in different directions from the optical center C3 of the metalens 120 illustrated in A of FIG. 9, and the intervals between the pillars are ideally the same. Thus, the structure of the metalens 120 is isotropic, and the metalens 120 can ensure the isotropy of the optical characteristics.

In practice, however, there is a limit to the size of the region in which one pillar can be disposed. Here, as illustrated in B of FIG. 9, regions 131 to 135 that have the same pattern of pillars and have the angle θf as the center angle are smaller in size at a shorter distance from the optical center C3. For example, the region 131 closest to the optical center C3 is the smallest, and the region 135 farthest from the optical center C3 is the largest. Therefore, in a case where the angle θf is small, as illustrated in A of FIG. 9, it is difficult to disposed pillars in all the regions 131 closest to the optical center C3, for example. That is, in the vicinity of the optical center C3, it is difficult to dispose pillars at intervals of the angle θf.

On the other hand, in a case where the angle θf is set to a great value so that the size of a region in which one pillar is disposed in the vicinity of the optical center C3 becomes a large enough size to accommodate a pillar, the intervals at which pillars away from the optical center C3 are arranged become more sparse in the circumferential direction, because the regions 131 to 135 are larger at a longer distance from the optical center C3. As a result, it is difficult to perform sufficient phase control in the peripheral region and achieve a high diffraction efficiency.

As described above, in the metalens 120 in which the pillars are arranged in polar coordinates at intervals of the constant angle θf as a whole, it is difficult to achieve both isotropy of optical characteristics and a high diffraction efficiency.

In the metalens 31 illustrated in FIG. 3, on the other hand, the center angle θᵢ of a peripheral region 72-i is greater than the center angle θⱼ of the peripheral region 72-j disposed on the outer side of the peripheral region 72-i, and thus, it is possible to prevent the arrangement intervals of the pillars 62 from becoming more sparse at a longer distance from the optical center C in the circumferential direction. As a result, even if the center angle θ; is set so that the size of the region in which one pillar 62 is disposed becomes a size capable of accommodating a pillar, the arrangement interval of the pillars 62 does not become more sparse in a peripheral region 72 at a longer distance from the optical center C in the circumferential direction. As a result, phase modulation is performed in the peripheral regions 72, and it is possible to prevent a decrease in diffraction efficiency due to phase modulation not being performed in the peripheral regions 72. Accordingly, both isotropy of the optical characteristics and a high diffraction efficiency can be achieved in the peripheral regions 72.

As described above, the metalens 31 has the peripheral regions 72 in which a plurality of pillars 62 is arranged in polar coordinates, and the center angle θᵢ of a peripheral region 72-i is greater than the center angle θⱼ of the peripheral region 72-j disposed on the outer side of the peripheral region 72-i. Accordingly, isotropy of the optical characteristics and a high diffraction efficiency can be achieved in the peripheral regions 72. Also, the pattern of the pillars 62 can be easily optimized.

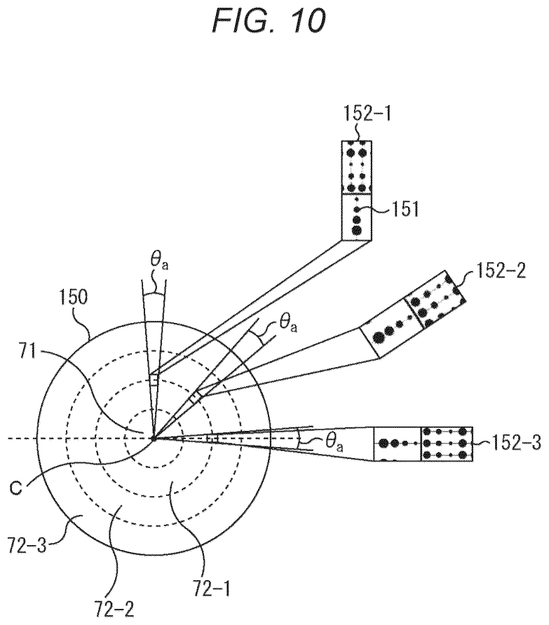

FIG. 10 is a top view of a metalens in a general case where there is no restriction that Mᵢ₊₁ is an integer smaller than 10 in the ratio between the center angles θᵢ of two adjacent peripheral regions 72 (a case where Mᵢ₊₁ is larger in an integer ratio Mᵢ:Mᵢ₊₁).

Note that, in a metalens 150 in FIG. 10, the portions corresponding to those of the metalens 31 in FIG. 3 are denoted by the same reference signs. Therefore, explanation of those portions is omitted herein as appropriate, and the different portions from those of the metalens 31 in FIG. 3 are mainly described. The metalens 150 in FIG. 10 differs from the metalens 31 in that Mᵢ₊₁ is not an integer smaller than 10 when the ratio between the center angles θᵢ of two adjacent peripheral regions 72 is expressed by an integer ratio Mᵢ:Mᵢ₊₁, and the other portions are similar to those of the metalens 31 in FIG. 3.

In this case, the relative positional relationship between the pillars 151 in two adjacent peripheral regions 72 at the boundary between the peripheral regions 72 might not be isotropic. For example, in regions 152-1 to 152-3 that are adjacent at the boundary between the peripheral region 72-1 and the peripheral region 72-2, and have the same center angle θₐ with respect to the optical center C but are in different directions, the relative positional relationships between the pillars 151 in the peripheral region 72-1 and the pillars 151 in the peripheral region 72-2 are different. Therefore, it is difficult to ensure the isotropy of the optical characteristics at the boundary between the peripheral regions 72. Also, when the metalens 150 is manufactured, a verification model for optical proximity correction (OPC) is complicated.

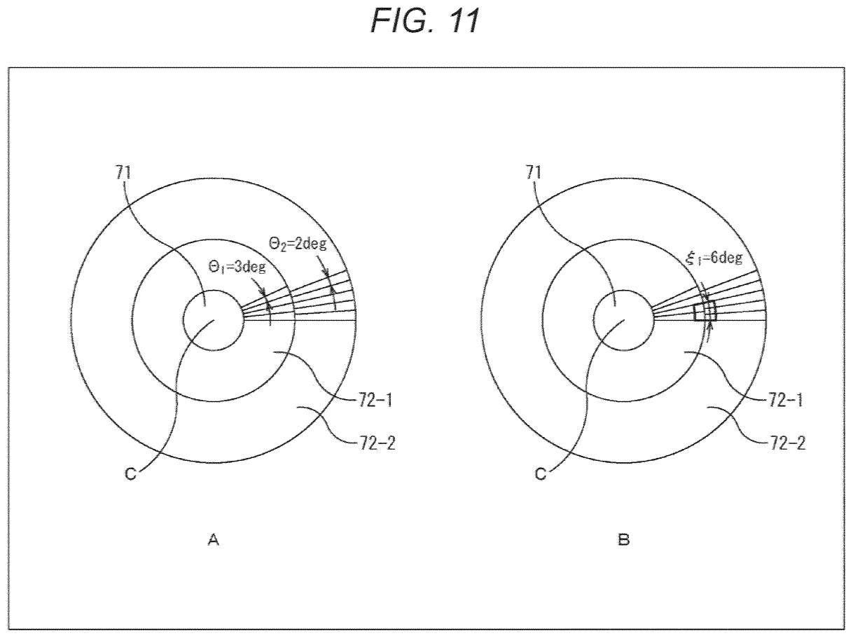

In the metalens 31 in FIG. 3, on the other hand, the ratio between the center angles θᵢ and θᵢ₊₁ is set so that Mᵢ₊₁ is an integer smaller than 10 when expressed as an integer ratio Mᵢ:Mᵢ₊₁, using disjoint positive integers Mᵢ and Mᵢ₊₁.

Where the greatest common divisor of the disjoint positive integers Mᵢ and Mᵢ₊₁ is represented by γᵢ, Mᵢ=Nᵢ₊₁/γᵢ using the number Nᵢ, and Mᵢ₊₁=Nᵢ/γᵢ. Further, the center angles θi and θᵢ₊₁ are expressed as θᵢ=Mᵢ×ψᵢ, and θᵢ₊₁=Mᵢ₊₁×ψᵢ₊₁, respectively, using a certain angle ψᵢ. Accordingly, the angular intervals Si in the vicinity of the boundary between two adjacent peripheral regions 72 (the intervals will be hereinafter referred to as the local angular intervals ξᵢ near the boundary) is expressed as ξᵢ=Qᵢ×ψᵢ, using the least common multiple Qᵢ=Mᵢ× Mᵢ₊₁ of the disjoint positive integers Mᵢ and Mᵢ₊₁. For example, in a case where M₁ is 3, M₂ is 2, and ψᵢ is 1 degree as illustrated in A of FIG. 11, the local angular intervals ξ₁ in the vicinity of the boundary between the peripheral region 72-1 and the peripheral region 72-2 is 6 degrees (=3×2×1) as illustrated in B of FIG. 11.

Here, the ratio between the center angle θᵢ and the local angular intervals ξᵢ near the boundary is expressed as θᵢ: ξᵢ=Mᵢ×ψᵢ:Qᵢ×ψᵢ=Mᵢ:Mᵢ×Mᵢ₊₁=1:Mᵢ₊₁. Accordingly, in a case where Mᵢ₊₁ is greater than 1, the angular intervals visible from a finite-size incident light flux increases to a value Mᵢ₊₁ times greater than the angular intervals θᵢ between the peripheral regions 72 near this boundary. An increase in the angular intervals means degradation in the isotropy of the optical characteristics, a decrease in diffraction efficiency due to generation of unnecessary diffracted light having a circumferential component, and an increase in difficulty in manufacture control by OPC. Therefore, in the metalens 31, Mᵢ₊₁ is limited to a positive integer smaller than 10. Thus, it is possible to prevent degradation of the isotropy of the optical characteristics, a decrease in diffraction efficiency due to generation of unnecessary diffracted light having a circumferential component, and an increase in difficulty in manufacture control by OPC. Note that the value of Mᵢ₊₁ is most desirably limited to 1, but the limit value of Mᵢ₊₁ is not necessarily smaller than 10, as long as the value can be limited to a small value.

### <Method for Designing a Metalens>

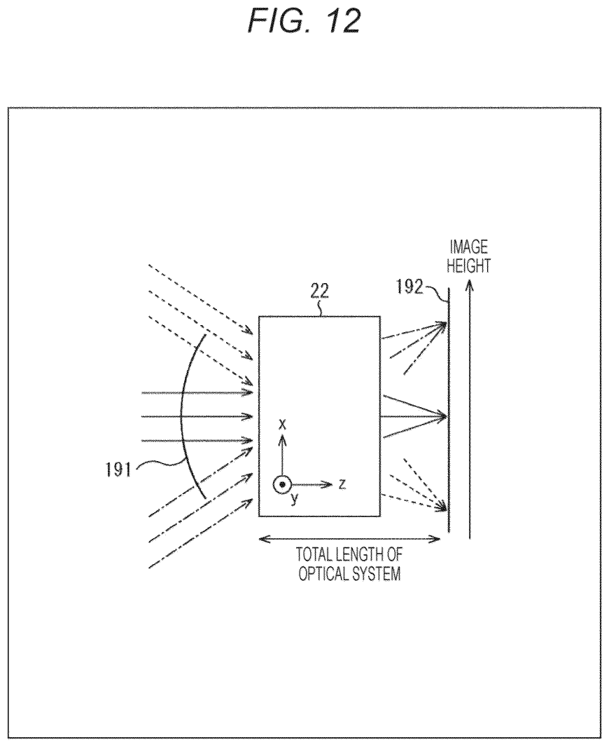

Next, referring to FIGS. 12 to 14, a method for designing the metalens 31 is described.

Before the metalens 31 is designed, the specification of the lens system 22 are formulated first. Specifically, as illustrated in FIG. 12, a FOV 191 of the lens system 22, the f-number, the sizes in the x direction and the y direction, the target value of the distance (the entire length of the optical system) from the light entering side of the lens system 22 to the image plane 192 of the CMOS image sensor 13, the correspondence relationship between the incident angle and the image height, and the like are formulated.

Next, according to the formulated specification, the lens system 22 is geometrically and optically designed. Specifically, a plurality of candidates for the lens configuration of the lens system 22 are set first. The lens configuration indicates the number of the lenses constituting the lens system 22, and the type of each lens. The type of each lens is a type of lens such as a bulk lens or a metalens, and includes the material of each lens, the manufacturing method, and the like in a case where the type of lens is a bulk lens. Next, for each candidate, geometric optical optimization (optimization of the curved surface of a bulk lens and the phase distribution of a metalens), characteristics prediction such as modulation transfer function (MTF) calculation, and the like are performed. A candidate optimal for the specification is then selected from among the candidates, and is determined to be the lens configuration of the lens system 22.

In a case where the lens configuration of the lens system 22 includes the metalens 31, for example, a library method is used to design the metalens 31 having a phase distribution optimized as the phase distribution of the metalens 31 at the time of determination of the lens configuration of the lens system 22.

By the library method, a table indicating the relationship between the radius of the pillars 62, and the phase to be modulated by the pillars 62 and the light transmittance of the pillars 62 is created and stored as a library. This library is created for each material of the pillars 62, for example.

The phase amount to be modulated by the pillars 62 is larger where the radius of the pillars 62 is greater. The reason for this is that, where the pillars 62 are larger, the occupancy of the embedding layer 63 having a lower refractive index than that of the pillars 62 in the metalens 31 is lower, and therefore, the average refractive index of the metalens 31 is higher.

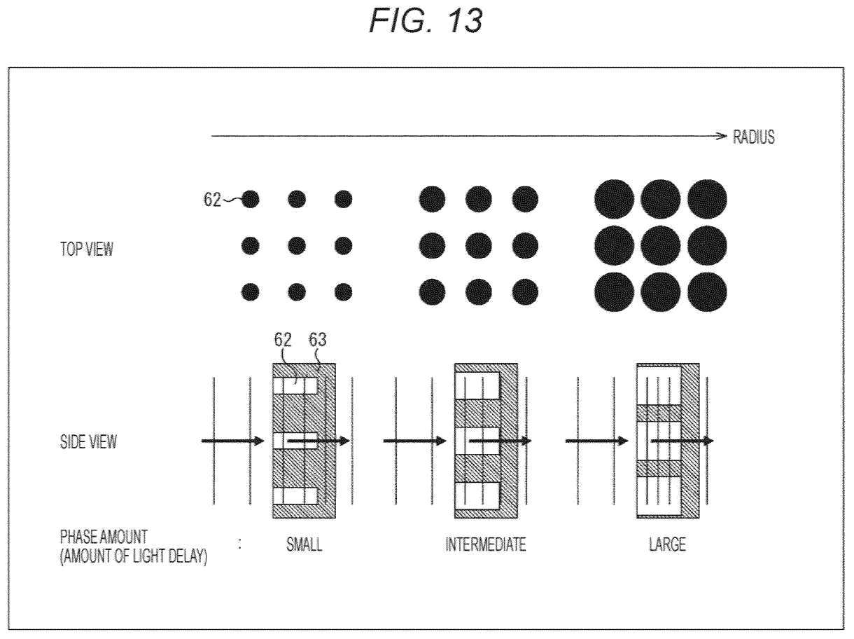

Specifically, the phases (phase amounts) to be modulated by the pillars 62 in cases where the radius of the pillars 62 is 40 nm, 60 nm, and 90 nm are described with reference to FIG. 13.

The upper portion of FIG. 13 shows top views of the pillars 62 arranged in the metalens 31 as viewed from above in a case where 3×3 pillars 62 are disposed, and the lower portion shows side views of the pillars 62 and the embedding layer 63 as viewed from a side. In FIG. 13, the left side shows a case where the radius of the pillars 62 is 40 nm, the center shows a case where the radius is 60 nm, and the right side shows a case where the radius is 90 nm.

As illustrated on the left side of the lower portion of FIG. 13, in the case where the radius of the pillars 62 is 40 nm, the region of the embedding layer 63 having a lower refractive index than that of the pillars 62 is large, and therefore, the average refractive index of the metalens 31 is low. Accordingly, the phase amount to be modulated by the pillars 62 is small. That is, the amount of light delay to be caused by the pillars 62 is small.

As illustrated in the center of the lower portion of FIG. 13, in the case where the radius of the pillars 62 is 60 nm, the region of the embedding layer 63 is smaller than that in the case where the radius is 40 nm, and therefore, the average refractive index of the metalens 31 is higher. Accordingly, the phase amount to be modulated by the pillars 62 is larger than that in the case where the radius of the pillars 62 is 40 nm. That is, the amount of light delay to be caused by the pillars 62 is larger than that in the case where the radius of the pillars 62 is 40 nm.

As illustrated on the right side of the lower portion of FIG. 13, in the case where the radius of the pillars 62 is 90 nm, the region of the embedding layer 63 is smaller than that in the case where the radius is 60 nm, and therefore, the average refractive index of the metalens 31 is higher. Accordingly, the phase amount to be modulated by the pillars 62 is larger than that in the case where the radius of the pillars 62 is 60 nm. That is, the amount of light delay to be caused by the pillars 62 is larger than that in the case where the radius of the pillars 62 is 60 nm.

By the library method, the size of each pillar 62 is determined on the basis of the library and the desired phase distribution of the metalens 31. Here, the desired phase distribution of the metalens 31 is the phase distribution that has been optimized as the phase distribution of the metalens 31 at the time of determination of the lens configuration of the lens system 22.

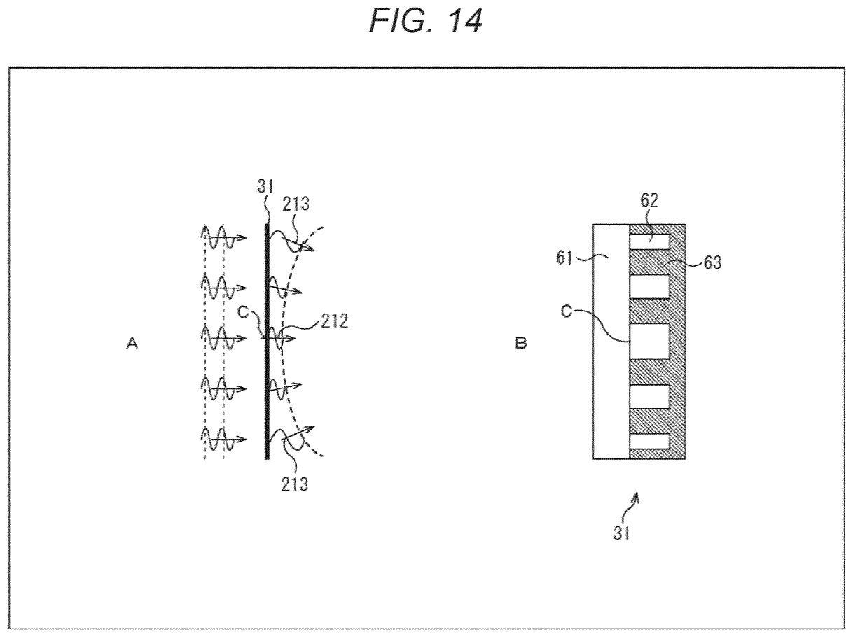

For example, in a case where the desired phase distribution of the metalens 31 is a phase distribution that is smaller at a longer distance from the center, the pattern of the pillars 62 disposed in the metalens 31 is determined to be the pattern of the pillars 62 illustrated in B of FIG. 14.

Specifically, A of FIG. 14 and B of FIG. 14 are side views of the metalens 31. As illustrated in A of FIG. 14, in a case where the desired phase distribution of the metalens 31 is a distribution in which the phase is smaller as a longer distance from the optical center C of the metalens 31, it is necessary to delay light 212 near the optical center C with the pillars 62, and quickly advance light 213 at the edge of the metalens 31 at a longer distance from the optical center C. That is, it is necessary to reduce the amount of light delay with the pillars 62 at a longer distance from the optical center C.

Here, as described with reference to FIG. 13, the smaller the radius of the pillars 62, the smaller the amount of light delay to be caused by the pillars 62. Therefore, as illustrated in B of FIG. 14, the size of each pillar 62 disposed on the substrate 61 of the metalens 31 is selected so as to be smaller at a longer distance from the optical center C. As a result, the desired phase distribution of the metalens 31 can be achieved, and thus, the desired lens function can be achieved.

### <Detailed Description of the Method for Optimizing the Pattern of Pillars in Peripheral Regions>

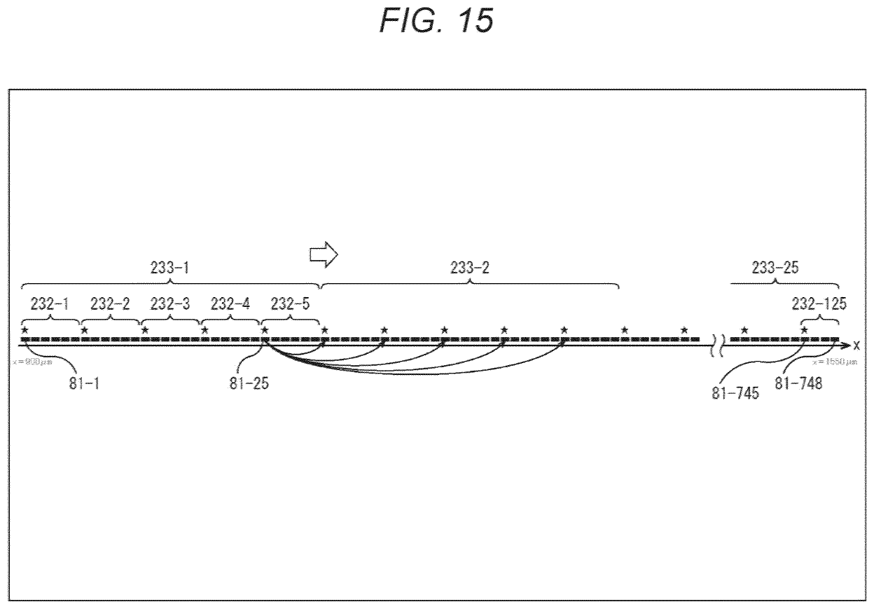

Next, the method for optimizing the pattern of the pillars 62 in a periodic region 73 is described in detail, with reference to FIGS. 15 to 17.

In FIGS. 15 to 17, the horizontal axis indicates the distance from the optical center C in the radial direction, and rectangles represent the unit regions 81. In the example illustrated in FIGS. 15 to 17, the radius on the inner side of each peripheral region 72 is 900 μm, and the radius on the outer side of each peripheral region 72 is 1550 μm. The number of the unit regions 81 in the periodic region 73 is 748.

In this case, the 748 unit regions 81-1 to 81-748 in the periodic region 73 are grouped into unit groups of six unit regions sequentially from the inner side, and are set as unit groups 232-1 to 232-125. Note that the last unit group 232-125 is formed with four unit regions 81-745 to 748. The unit groups 232-1 to 232-125 are further grouped into parallel unit groups of five unit groups sequentially from the inner side, and set as parallel unit groups 233-1 to 233-25, which are units for performing optimization in parallel. Note that, in the description below, in a case where there is no particular need to distinguish the unit groups 232-1 to 232-125 from one another, they will be collectively referred to as the unit groups 232. Likewise, the parallel unit groups 233-1 to 232-25 will be collectively referred to as the parallel unit groups 233.

In the example in FIGS. 15 to 17, the number Period_opt of the unit regions 81 constituting a unit group 232 is set to six, and the number Num_Parallel_opt of the unit groups 232 constituting a parallel unit group 233 is set to five. However, Period_opt and Num_Parallel_opt are not limited to these numbers, as long as they are integers of 1 or greater. For example, Period_opt may be ten, while Num_Parallel_opt may be five.

In the optimization of the pattern of the pillars 62 in the peripheral regions 72, parallel optimization is first performed on the innermost parallel unit group 233-1 in the periodic region 73, using a standard electromagnetic field analysis technique such as RCWA.

Specifically, a predetermined number (for example, 2000) of patterns are randomly generated as candidates for the pattern of the pillars 62 in the innermost unit region 81-1 in the periodic region 73. The respective candidates may be generated by varying all the elements of the patterns of the pillars 62, or may be generated by varying only the positions and sizes of the respective pillars 62 and setting the type of shape of each pillar 62 and the number of pillars 62 of each shape to a predetermined type and number corresponding to the size of the unit region 81-1.

By RCWA or the like, among the generated candidates, the candidate having the highest figure of merit A such as the average value of diffraction efficiency with respect to the incident angles at ten representative points selected from the incident angle range in the unit region 81-1 is selected. The selected candidate is set as the initial pattern common in the innermost parallel unit group 233-1 in the periodic region 73, and optimization is performed in parallel on the innermost unit regions 81 of the five respective unit groups 232 constituting the parallel unit group 233-1. The objective function of this optimization is an average value of diffraction efficiency with respect to the incident angles at ten representative points selected from the incident angle range in each unit region 81, for example.

After the parallel optimization is performed on the parallel unit group 233-1, a copy of the optimized pattern of the innermost unit region 81-25 of the outermost unit group 232-5 in the parallel unit group 233-1 is set as the initial pattern, and parallel optimization is performed on the second parallel unit group 233-2 from the inner side in the periodic region 73. Thereafter, parallel optimization for each parallel unit group 233 is performed from the inner side to the outer side in a manner similar to the above, and parallel optimization for the outermost parallel unit group 233-25 in the periodic region 73 is performed at last.

As described above, parallel optimization is performed from the inner side to the outer side in the periodic region 73, while the optimized pattern of the innermost unit region 81-1 in the periodic region 73 is taken over as the initial pattern. As a result, the calculation time for optimization can be shortened. However, in a case where the figure of merit A becomes equal to or lower than a threshold, the initial pattern is reset.

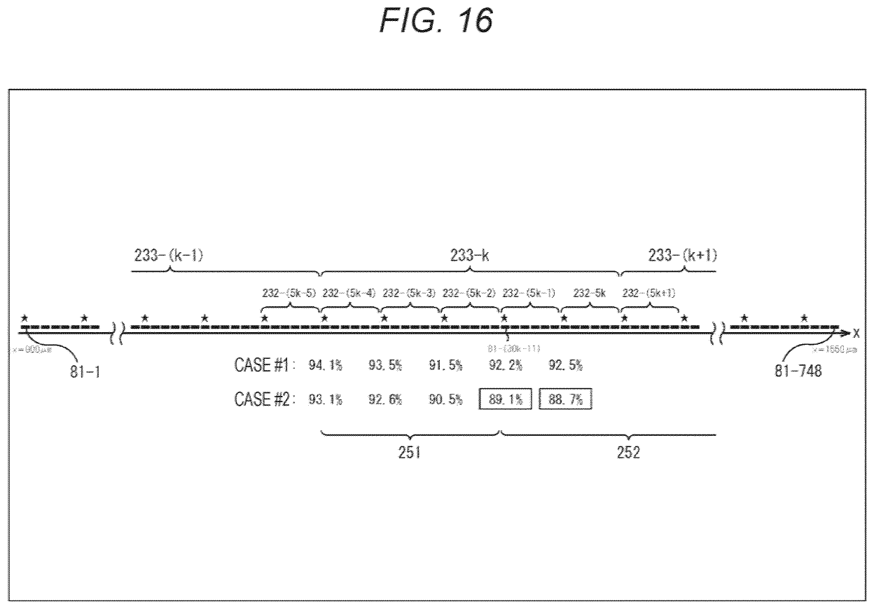

Specifically, as illustrated in FIG. 16, if it is assumed that the current parallel optimization target is the parallel unit group 233-k (k being an integer of 2 or greater), optimization is performed in parallel on the five unit groups 232-(5k−4) to 232-5k in the parallel unit group 233-k. A check is then made to determine whether or not the figure of merit A corresponding to the optimized pattern of any one of the unit groups 232-(5k−4) to 232-5k is equal to or lower than the threshold value.

This threshold is the value obtained by subtracting a predetermined value ΔA from a reference value A^{ref} when the figure of merit A corresponding to the outermost unit group 232-(5k−5) in the previous parallel unit group 233-(k−1) subjected to parallel optimization is set as the reference value A^{ref}. In the example in FIG. 16, the figure of merit A corresponding to the unit group 232-(5k−5) is 94.2%, and the predetermined value ΔA is 5%. Accordingly, the threshold is 89.2%.

In this case, as illustrated in FIG. 16, for example, in a case #1 where the figures of merit A corresponding to the unit groups 232-(5k−4) to 232-5k are 94.1%, 93.5%, 91.5%, 92.2%, and 92.5% in this order, all the figures of merit A of the unit groups 232-(5k−4) to 232-5k are higher than the threshold. Therefore, the initial pattern is not reset in this case. Parallel optimization is performed on the next parallel unit group 233-(k+1), the initial pattern being the optimized pattern corresponding to the outermost unit group 232-5k in the parallel unit group 233-k. Note that the reference value A^{ref} corresponding to the parallel unit group 233-(k+1) is the figure of merit A (92.5% in the example in FIG. 16) corresponding to the outermost unit group 232-5k in the previous parallel unit group 233-k.

On the other hand, as illustrated in FIG. 16, in a case #2 where the figures of merit A corresponding to the unit groups 232-(5k−4) to 232-5k are 93.1%, 92.6%, 90.5%, 89.1%, and 88.7% in this order, the figures of merit A of the unit groups 232-(5k−1) and 232-5k are equal to or lower than the threshold. Therefore, the initial pattern to be used at the time of optimization of the innermost unit group 232-(5k−1) in which the figure of merit A is equal to or lower than the threshold is reset.

Specifically, the optimized pattern is adopted only for the parallel unit group 251 formed with the three unit groups 232-(5k−4) to 232-(5k−2), and the optimized pattern is not adopted for the unit groups 232-(5k−1) and 232-5k. A parallel unit group 252 formed with five unit groups 232-(5k−1) to 232-(5k+3) including the unit group 232-(5k−1) at the innermost side is then set as the next parallel optimization target. The subsequent unit groups 232 are also turned into groups of five unit groups to form new parallel unit groups to be sequentially subjected to parallel optimization.

The optimization of the parallel unit group 252 is similar to the optimization of the innermost parallel unit group 233-1 in the periodic region 73. That is, a predetermined number (for example, 2000) of patterns are randomly generated as candidates for the pattern of the pillars 62 in the innermost unit region 81-(30k−11) in the parallel unit group 252. Among the generated candidates, the candidate having the highest figure of merit A is selected. The selected candidate is set as the initial pattern common in the parallel unit group 252, and optimization is performed in parallel on the innermost unit regions 81 of the respective unit groups 232 constituting the parallel unit group 252.

The determination as to whether there is a unit group 232 whose figure of merit A is equal to or lower than the threshold as above, or the determination as to whether to reset the initial pattern, is performed for each parallel unit group 251. In a case where there is a unit group 232 whose figure of merit A is equal to or lower than the threshold, the initial pattern is reset in the innermost unit group 232 among the unit groups 232.

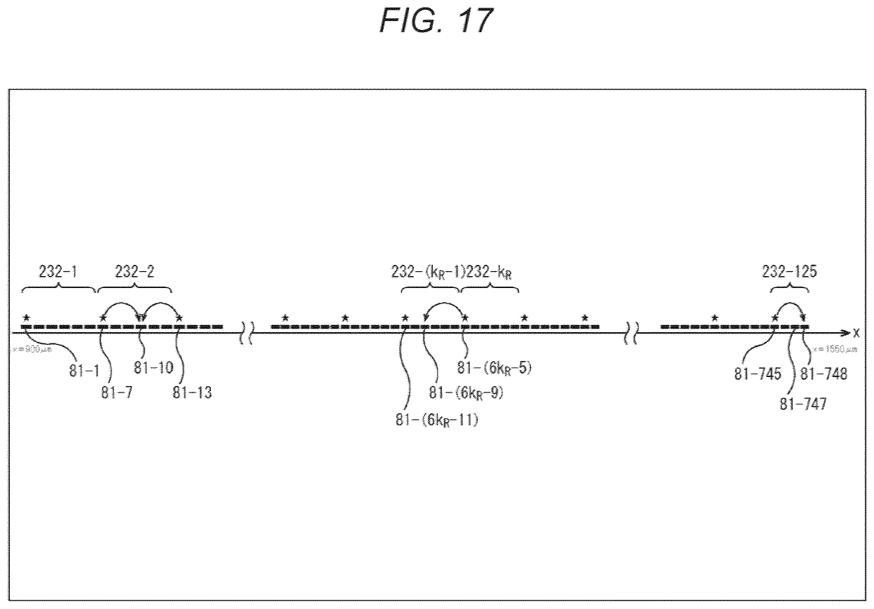

Note that the determination of the pattern for the unit regions 81 other than the innermost unit region 81 in each unit group 232 is performed as illustrated in FIG. 17, using the optimized pattern of the innermost unit regions 81.

In the example in FIG. 17, the initial pattern is reset in the unit group 232-k_{R} (k_{R} being an integer of 2 or greater and 125 or smaller). In this case, the optimization of the unit region 81 to be optimized is performed basically through interpolation using the pattern of the optimized unit regions 81 closest on the inner side and the outer side of the unit region 81 to be optimized.

For example, as illustrated in FIG. 17, the optimization value of the pattern of the fourth unit region 81-10 from the inner side in the unit group 232-2 is obtained by interpolation using the pattern of the optimized unit region 81-7 closest on the inner side of the unit region 81-10 and the pattern of the optimized unit region 81-13 closest on the outer side of the unit region 81-10. As for the method of interpolation, for example, there is a method by which weighting and adding is performed on each pattern to be used for the interpolation, on the basis of the distance between the unit region 81 corresponding to each pattern to be used for the interpolation and the unit region 81 corresponding to the pattern to be interpolated.

Note that, exceptionally, in a case where the optimized unit region 81 closest on the outer side of the unit region 81 to be optimized is the innermost unit region 81-(6k_{R}−5) in the unit group 232-k_{R} whose initial pattern has been reset, the optimization is performed by copying the optimized pattern of the unit region 81-(6k_{R}−5).

For example, as illustrated in FIG. 17, the optimized unit region 81 closest on the outer side of the third unit region 81-(6k_{R}−9) from the inner side in the unit group 232-(k_{R}−1) is the unit region 81-(6k_{R}−5). Accordingly, the optimization value of the pattern of the unit region 81-(6k_{R}−9) is a copied value of the optimized pattern of the unit region 81-(6k_{R}−5).

Also, exceptionally, in a case where there is not an optimized unit region 81 closest on the outer side of the unit region 81 to be optimized, or in a case where the unit region 81 to be optimized is a unit region 81 in the outermost unit group 232-125, optimization is performed by copying the pattern of the optimized unit region 81 closest on the inner side of the unit region 81 to be optimized.

For example, as illustrated in FIG. 17, the optimization value of the pattern of the third unit region 81-747 from the inner side in the unit group 232-125 is a copied value of the pattern of the optimized unit region 81-745 closest on the inner side of the unit region 81-747.

Note that a copied value of an optimized pattern is the value obtained by scaling the optimized pattern of the copy source in accordance with the size of the unit region 81 corresponding to the copy destination.

In the above manner, the innermost unit region 81 of each unit group 232 in the periodic region 73 is optimized in parallel for each parallel unit group 233 sequentially from the inner side, and after that, the pattern of the remaining unit regions 81 is determined using the optimized unit region 81. As a result, the patterns of the pillars 62 in all the unit regions 81 in the peripheral region 72 are optimized.

As described above, in designing the metalens 31, the optimization of the innermost unit region 81 in each unit group 232 is basically performed while taking over the optimized pattern on the further inner side as the initial pattern. Also, optimization of the unit regions 81 other than the innermost unit region 81 in each unit group 232 is performed basically through interpolation of the pattern of the optimized unit region 81.

Accordingly, a pair of patterns of two adjacent unit regions 81 has similarity. Because of this, in the metalens 31, two-dimensional periodicity in which each unit region 81 is set as a unit period, and the radial direction and a direction perpendicular to the radial direction are set as the respective dimensions is approximately established. Accordingly, by applying a standard electromagnetic field analysis technique such as RCWA to each unit region 81 before the manufacture of the metalens 31, the optical characteristics of the metalens 31 can be efficiently predicted with high accuracy. As a result, the development costs such as the development period of the design of the metalens 31 can be lowered. Furthermore, manufacture control by OPC becomes easier.

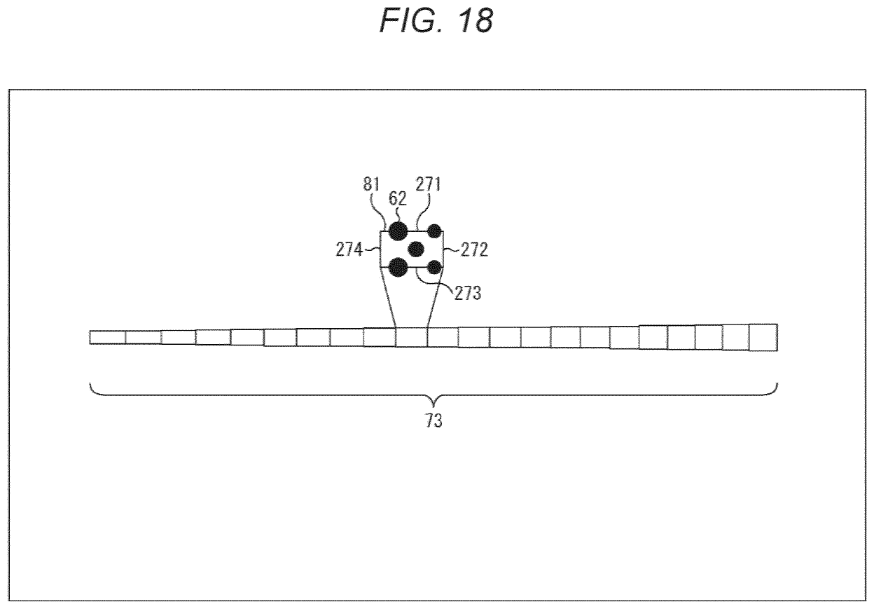

Note that, in a case where optimization is performed on each unit region 81, a periodic boundary condition is imposed on each of the four sides 271 to 274 of each unit region 81, as illustrated in FIG. 18. As a result, the pattern of the pillars 62 in each unit region 81 is optimized so that the optical characteristics realized at the position of each unit region 81 under a virtual situation where the pattern of the pillars 62 is periodically repeated in the planar direction become closer to desired optical characteristics. Therefore, the optimized pattern of the pillars 62 is set as a pattern having optical characteristics close to desired optical characteristics, the interaction between adjacent pillars 62 in the entire metalens 31 being taken into consideration. Thus, it is easy to achieve desired optical characteristics in the metalens 31.

The optical characteristics of each unit region 81 can be efficiently predicted with high accuracy by an electromagnetic field analysis technique such as RCWA. In the example in FIG. 18, the periodic region 73 is divided into twenty-two unit regions 81.

In designing the metalens 31, optimization is performed in parallel on the respective parallel unit groups 233, the calculation time in the optimization can be shortened. For example, when optimization for each unit group 232 in a parallel unit group 233 is performed in parallel in each core of a many-core central processing unit (CPU), the calculation time in the optimization is about 1/Num_Parallel_opt times as long as that in a case where the optimization is sequentially performed using only one core.

Note that the optimization method is not limited to the method described with reference to FIGS. 15 to 18, as long as the respective unit groups 232 can be optimized sequentially in the radial direction by taking over the initial pattern or adding the penalty regarding the difference between the patterns of the pillars 62 of two adjacent unit groups 232 to the objective function of the optimization. As for the method for taking over the initial pattern, there also is a method by which a predetermined pattern common to all the unit groups 232 is set as the initial pattern, for example.

In a case where the initial pattern is not reset in the periodic region 73 at the time of optimization, the patterns of the pillars 62 of all the pairs of adjacent unit regions 81 in the periodic region 73 have similarity. However, in a case where the initial pattern is reset, the patterns of the pillar 62 are switched at the position of the boundary between the reset unit region 81 and the unit region 81 on the inner side of the reset unit region 81.

### <Other Examples of Patterns of Pillars in a Periodic Region>

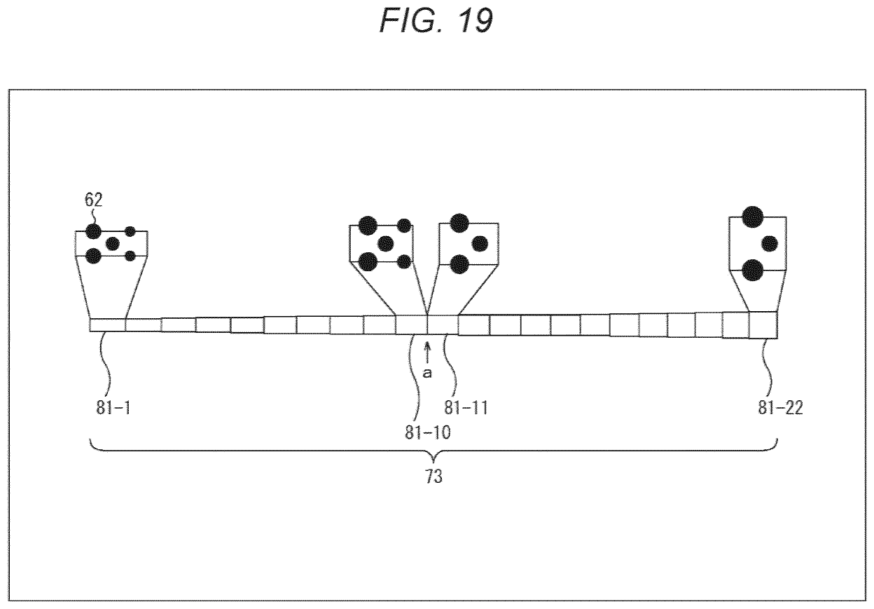

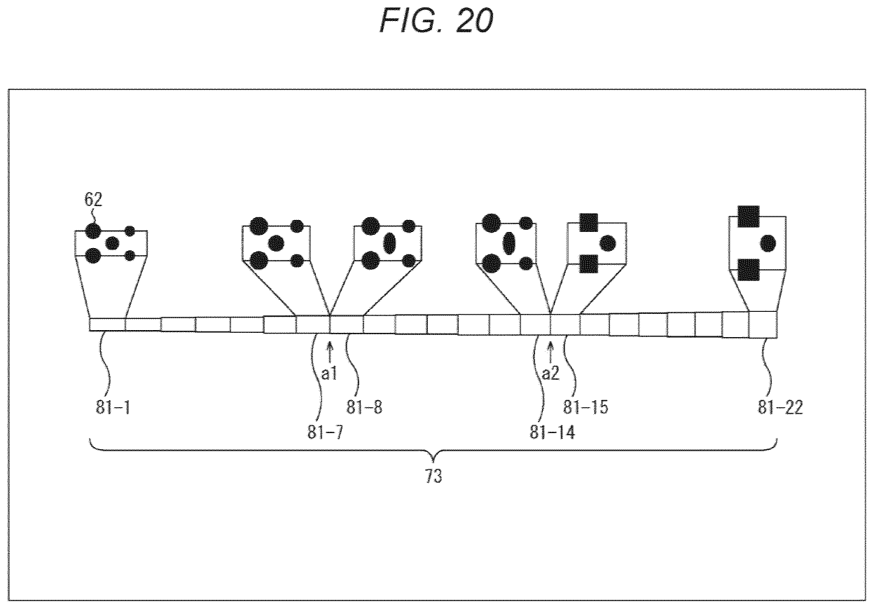

FIGS. 19 and 20 are top views of a periodic region 73, illustrating examples of patterns of the pillars 62 in a periodic region 73 in this case.

In the examples in FIGS. 19 and 20, the periodic region 73 is formed with twenty-two unit regions 81-1 to 81-22.

In the example in FIG. 19, the initial pattern is reset in the unit region 81-11 at the time of optimization. Therefore, patterns of the pillars 62 are switched at the position a of the boundary between the unit regions 81-10 and 81-11.

Specifically, the number of pillars 62 is three in the unit regions 81-1 to 81-10 on the inner side of the position a, but the number of disposed pillars 62 is two in the unit regions 81-11 to 81-22 on the outer side of the position a. Therefore, in the adjacent unit regions 81-10 and 81-11 having the position a interposed in between, the numbers of pillars 62 are different, and similarity between the patterns of the pillars 62 is lost. Note that, in the example in FIG. 19, the shape of all the pillars 62 disposed in each unit region 81 is a column-like shape.

In the example in FIG. 20, the initial pattern is reset in the unit region 81-8 and the unit region 81-15 at the time of optimization. Therefore, patterns of the pillars 62 are switched at the position a1 of the boundary between the unit regions 81-7 and 81-8, and at the position a2 of the boundary between the unit regions 81-14 and 81-15.

Specifically, in the unit regions 81-1 to 81-7 on the inner side of the position a1, three columnar pillars 62 are disposed. In the unit regions 81-8 to 81-14 on the outer side of the position a1 and on the inner side of the position a2, two columnar pillars 62 and one elliptic columnar pillar 62 are disposed. In the unit regions 81-15 to 81-22 on the outer side of the position a2, one cubic pillar 62 and one columnar pillar 62 are disposed.

As described above, in the case of the example in FIG. 20, the type of the shape of the pillars 62 and the number of pillars 62 in each shape vary between the adjacent unit regions 81-7 and 81-8 having the position a1 interposed in between, and between the adjacent unit regions 81-14 and 81-15 having the position a2 interposed in between, and similarity among the patterns of the pillars 62 is lost.

Note that, if the number of pattern switching positions among the pillars 62, or the number of positions at which the initial pattern is reset at the time of optimization, is too large, similarity between the patterns of the pillars 62 in each pair of adjacent unit regions 81 in the entire periodic region 73 is lost. Therefore, the number of pattern switching positions among the pillars 62 needs to be limited.

### <First Example of the Condition for the Number of Pillar Pattern Switching Positions>

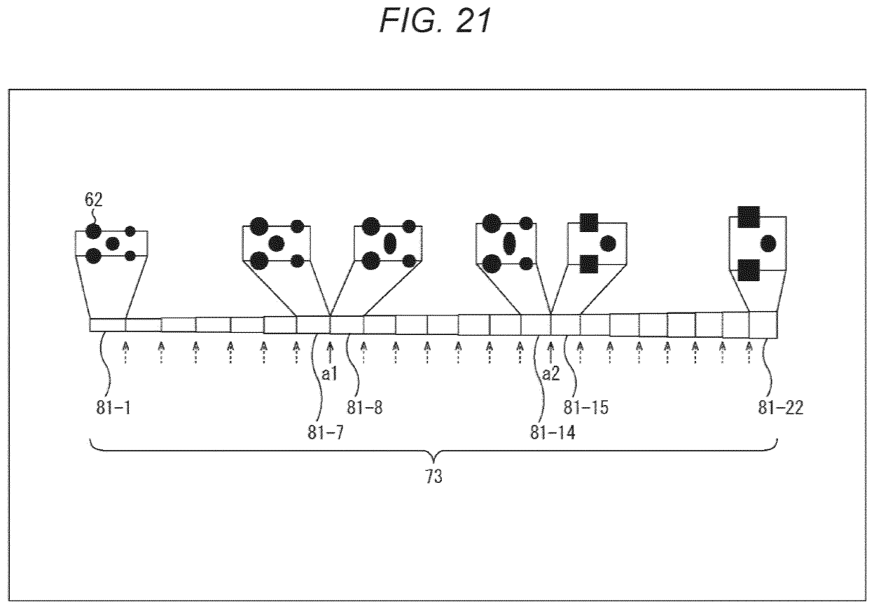

FIG. 21 is a diagram illustrating a first example of the condition for the number of pattern switching positions among the pillars 62.

Under the condition illustrated in FIG. 21, the number of pattern switching positions among the pillars 62 is set so that the ratio of the value obtained by subtracting the number of switching positions from the total number of all pairs of adjacent unit regions 81 in the periodic region 73 to the total number of all pairs is equal to or higher than 90%. That is, the number of switching positions is set so that the ratio of the number of boundary positions that are not switching positions to the total number of boundary positions among the unit regions 81 in the periodic region 73 is equal to or higher than 90%. In other words, the number of switching positions is set so that the ratio of the number of switching positions to the total number of boundary positions among the unit regions 81 in the periodic region 73 is lower than 10%.

For example, as illustrated in FIG. 21, in a case where the number of the unit regions 81 in the periodic region 73 is twenty-two, the total number of boundary positions among the unit regions 81 indicated by solid and dotted arrows in FIG. 21 is 21 (=22−1). Therefore, to satisfy the condition in FIG. 21, the number of switching positions needs to be set to a smaller number than 2.1 (=21/10). In the example in FIG. 21, the number of switching positions is two, which are the positions a1 and a2 indicated by solid arrows in FIG. 21, and thus, the number of switching positions satisfies the condition in FIG. 21.

### <Second Example of the Condition for the Number of Pillar Pattern Switching Positions>

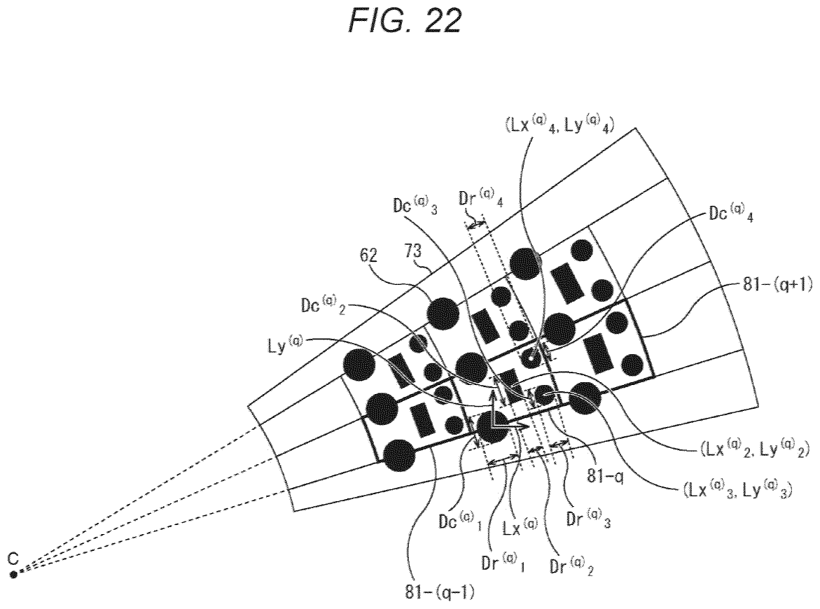

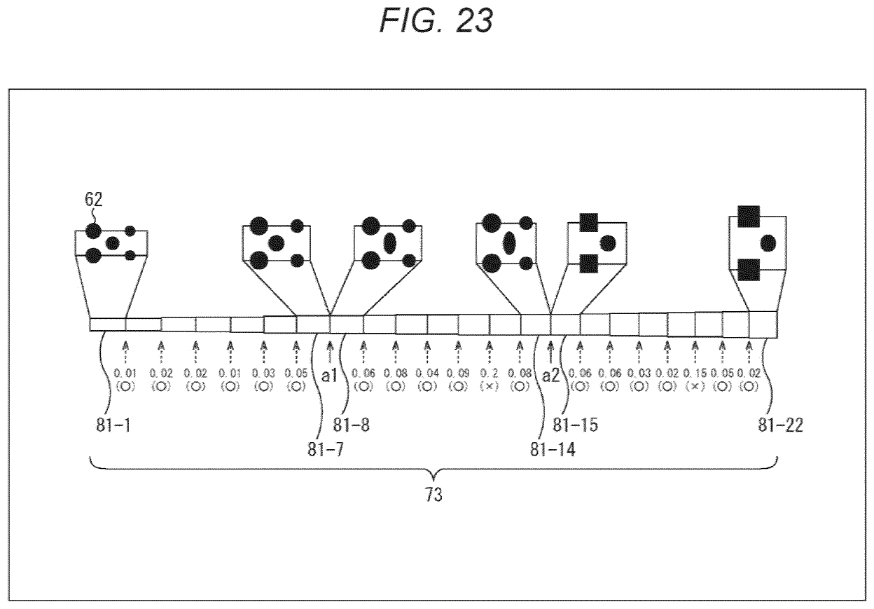

Next, a second example of the condition for the number of pattern switching positions among the pillars 62 is described with reference to FIGS. 22 and 23.

FIG. 22 is a diagram illustrating an example of a method of expressing a pattern of the pillars 62.

As illustrated in FIG. 22, a local orthogonal coordinate system (Lx^{(q)}, Ly^{(q)}) is set at the center of one pillar 62 among n (n being an integer of 1 or greater, and 4 in the example in FIG. 22.) pillars 62 disposed in the q-th (q being an integer of 1 or greater) unit region 81-q from the inner side in the periodic region 73, the center of the one pillar 62 being the origin of the local orthogonal coordinate system. In this case, the coordinate values of the pillars 62, at the centers of which the origin of the orthogonal coordinate system (Lx^{(q)}, Ly^{(q)}) is not set, can be expressed as (Lx^{(q)}₂, Ly^{(q)}₂), (Lx^{(q)}₃, Ly^{(q)}₃), . . . , and (Lx^{(q)}ₙ, Ly^{(q)}ₙ), respectively, in the orthogonal coordinate system (Lx^{(q)}, Ly^{(q)}).

Here, the widths of the n pillars 62 in the radial direction of the metalens 31 are represented by Dr^{(q)}₁, Dr^{(q)}₁, . . . , and Dr^{(q)}ₙ, and the widths thereof in the circumferential direction are represented by Dc^{(q)}₁, Dc^{(q)}₁, . . . , and Dc^{(q)}ₙ. In this case, the parameter P (q) representing the pattern of the pillars 62 in the unit region 81-q can be defined by the following Expression (1).

$$P ( q ) = ( {Lx}_{2}^{( q )} , {Lx}_{3}^{( q )} , … , {Lx}_{n}^{( q )} , {Ly}_{2}^{( q )} , {Ly}_{3}^{( q )} , … , {Ly}_{n}^{( q )} , {Dr}_{1}^{( q )} , {Dr}_{2}^{( q )} , … , {Dr}_{n}^{( q )} , {Dc}_{1}^{( q )} , {Dc}_{2}^{( q )} , … , {Dc}_{n}^{( q )} ) \qquad ( 1 )$$

In a case where the type of the shape of the pillar 62 and the number of pillars 62 of each shape are common in a pair of adjacent unit regions 81-q and 81-(q+1), a difference amount Q(q) indicating the difference between the patterns of this pair can be defined by the following Expression (2).

$${Q}^{( q )} = \vert {P}^{( q + 1 )} - {P}^{( q )} \vert / \vert {P}^{( q )} \vert \qquad ( 2 )$$

Here, |P_{(q+1)}−P^{(q)}| is expressed by the following Expression (3), and |P^{(q)}| is expressed by the following Expression (4).

$$\begin{matrix}[ Math . 1 ] & \\ \vert {P}^{( q + 1 )} - {P}^{( q )} \vert = \sqrt{\begin{matrix}{\sum }_{k = 2}^{n} \{ {( {Lx}_{k}^{( q + 1 )} - {Lx}_{k}^{( q )} )}^{2} + {( {Ly}_{k}^{( q + 1 )} - {Ly}_{k}^{( q )} )}^{2} \} + \\ {\sum }_{k = 1}^{n} \{ {( {Dr}_{k}^{( q + 1 )} - {Dr}_{k}^{( q )} )}^{2} + {( {Dc}_{k}^{( q + 1 )} - {Dc}_{k}^{( q )} )}^{2} \}\end{matrix}} & ( 3 )\end{matrix}$$

$$\begin{matrix}[ Math . 2 ] & \\ \vert {P}^{( q )} \vert = \sqrt{{\sum }_{k = 2}^{n} \{ {( {Lx}_{k}^{( q )} )}^{2} + {( {Ly}_{k}^{( q )} )}^{2} \} + {\sum }_{k = 1}^{n} \{ {( {Dr}_{k}^{( q )} )}^{2} + {( {Dc}_{k}^{( q )} )}^{2} \}} & ( 4 )\end{matrix}$$

Where the difference amount Q^{(q)} is smaller, the similarity between the patterns of the pair of the unit regions 81-q and 81-(q+1) is higher.

FIG. 23 is a diagram illustrating an example of the condition for the number of pattern switching positions among the pillars 62, using the difference amount Q.

Under the condition illustrated in FIG. 23, the number of pattern switching positions among the pillars 62 is set so that the ratio of the number of pairs satisfying the similarity condition that the type of the shape of the pillars 62 and the number of pillars 62 of each shape are equal, and the difference amount Q^{(q)} is smaller than 0.1, to the total number of all pairs of adjacent unit regions 81 in the periodic region 73 is equal to or higher than 90%.

That is, the number of switching positions is set so that the sum of the number of switching positions and the number of pairs having a difference amount Q^{(q)} of 0.1 or larger at the boundary positions that are interposed therebetween but are not switching positions, to the total number of all pairs of adjacent unit regions 81 in the periodic region 73 is lower than 10%.

For example, as illustrated in FIG. 23, in a case where the number of the unit regions 81 in the periodic region 73 is twenty-two, the total number of boundary positions among the unit regions 81 indicated by solid and dotted arrows in FIG. 23 is 21 (=22−1). Therefore, to satisfy the condition in FIG. 23, the sum of the number of switching positions and the number of pairs having a difference amount Q^{(q)} of 0.1 or larger at the boundary positions that are interposed therebetween but are not switching positions needs to be set to a smaller value than 2.1 (=21/10).

In the example in FIG. 23, the switching positions are the two positions a1 and a2 indicated by solid arrows in FIG. 23. The difference amounts Q^{(q)} in the pairs of adjacent unit regions interposing boundary positions that are not the switching positions as indicated by dotted arrows in FIG. 23 are 0.01, 0.02, 0.02, 0.01, 0.03, 0.05, 0.06, 0.08, 0.04, 0.09, 0.2, 0.08, 0.06, 0.06, 0.03, 0.02, 0.15, 0.05, and 0.02 in this order from the inner side. Therefore, the number of pairs of adjacent unit regions having a difference amount Q^{(q)} of 0.1 or larger at the boundary positions that are interposed therebetween but are not the switching positions is two. Accordingly, the sum of the number of switching positions and the number of pairs of adjacent unit regions having a difference amount Q^{(q)} of 0.1 or larger at the boundary positions that are interposed therebetween but are not the switching positions is four, and the number of switching positions does not satisfy the condition in FIG. 23.

### <Detailed Description of the Method for Optimizing the Pattern of Pillars in the Center Region>

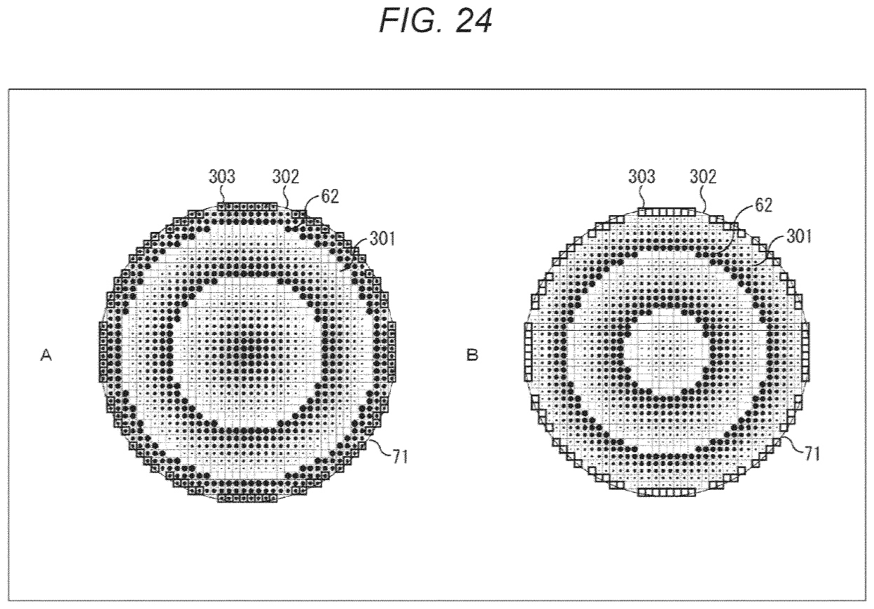

Next, the method for optimizing the pattern of the pillars 62 in the center region 71 is described in detail, with reference to FIGS. 24 to 26.

FIG. 24 is top views of the center region 71, illustrating examples of the patterns of the pillars 62 in the center region 71.

In the example in FIG. 24, the pillars 62 are arranged on a square lattice in the center region 71. That is, zero or one pillar 62 is disposed in each lattice cell 301 whose center is located in the center region 71, the lattice cells being represented by rectangles in A and B of FIG. 24. In this case, as illustrated in A of FIG. 24, there is a possibility that some pillars 62 are disposed in the lattice cells 303 among the lattice cells 301 (to be more exact, the lattice cells 303 in which the centers of these lattice cells 301 are included in the center region 71, but these lattice cells 301 partially protrude into the peripheral region 72-1) including the boundary 302 in regions in the vicinity of the boundary 302 between the center region 71 and the peripheral region 72-1, as indicated by bold rectangles in A of FIG. 24. As the pillars 62 are disposed in the lattice cells 303, those pillars 62 partially protrude into the peripheral region 72-1, which affects the optimization of the pattern of the pillars 62 in the peripheral region 72-1.

Therefore, as illustrated in B of FIG. 24, it is desirable that the pillars 62 be not disposed in the lattice cells 303 represented by bold rectangles in B of FIG. 24. Accordingly, the phase distribution of the metalens 31 is offset so that the lattice cells 303 become non-placement regions in which the pillars 62 are not disposed.

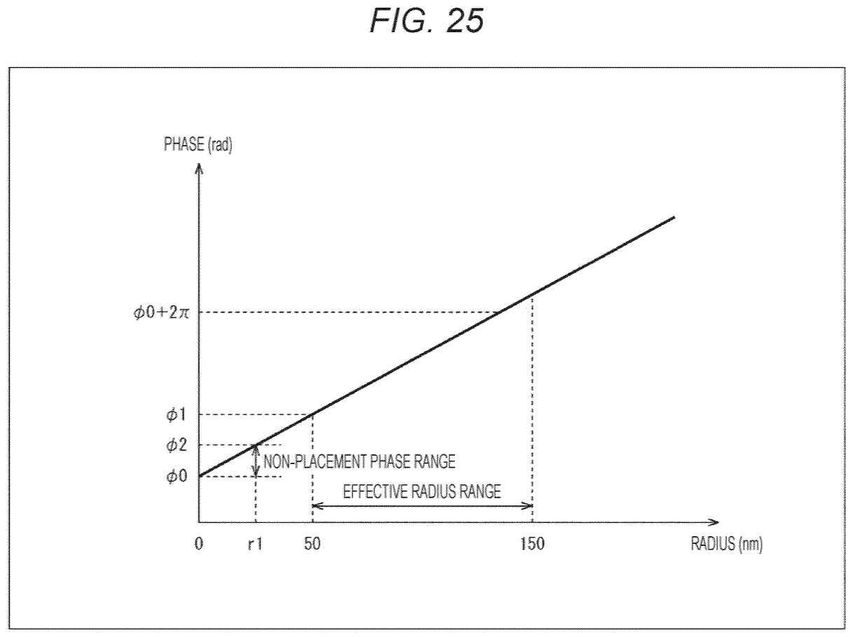

Specifically, the relationship between the radius of the pillars 62 and the phase amount to be modulated by the pillars 62 is illustrated in a graph in FIG. 25, for example. In FIG. 25, the abscissa axis indicates the radius (nm) of the pillars 62, and the ordinate axis indicates the phase (phase amount) (rad) to be modulated by the pillars 62. In the example in FIG. 25, the effective radius range, which is the range of the radii of the pillars 62 that can be manufactured, is the range of 50 nm to 150 nm.

In this case, there exist no pillars 62 capable of modulating the phase (phase amount) in the range of φ0 to φ1 corresponding to the radii in the range of 0 nm to 50 nm, which is narrower than the effective radius range. Therefore, in the phase distribution of the metalens 31, the pillars 62 are not disposed at the positions corresponding to phases in the range of φ0 to φ2 corresponding to radii in the range of 0 nm to r1 nm (r1<50). The pillars 62 having a minimum radius of 50 nm are disposed at the positions corresponding to phases in the range of φ1 to φ2 corresponding to radii in the range of r1 nm to 50 nm.

That is, a region in which the phases in the range of φ0 to φ2 are set in the phase distribution of the metalens 31 is a non-placement region in which the pillars 62 are not disposed. Therefore, the range of phases φ0 to φ2 will be hereinafter referred to as the non-placement phase range, which is the range of phases corresponding to the regions in which the pillars 62 are not disposed.

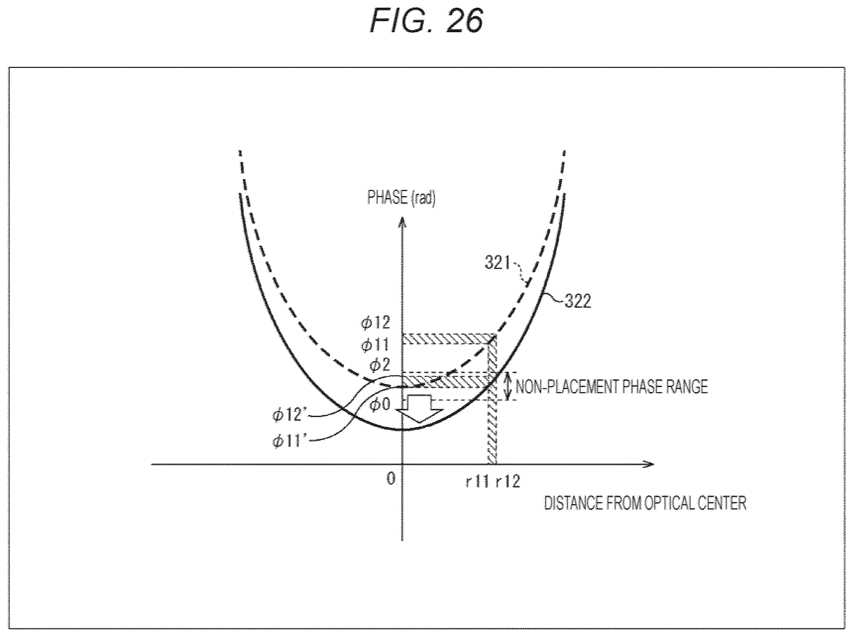

Since the pillars 62 are not disposed in the non-placement region as described above, the phase distribution of the metalens 31 is offset so that the lattice cells 303 are included in the non-placement region. For example, in a case where the phase distribution of the metalens 31 is a phase distribution 321 illustrated in FIG. 26, and the range of the distances from the optical center C to the lattice cells 303 are in the range of r11 to r12, the range of the phases corresponding to the range is the range of φ11 to φ12. Note that, in FIG. 26, the abscissa axis indicates the distance from the optical center C, and the ordinate axis indicates the phase (phase amount) (rad) to be modulated by the pillars 62.

As illustrated in FIG. 26, in a case where the range of φ11 to φ12 is not included in the non-placement phase range, the pillars 62 are disposed in the lattice cells 303. Therefore, the phase distribution 321 is offset (is moved downward in the example in FIG. 26), and a phase distribution 322 in which the phases corresponding to a region where the distance from the optical center C is in the range of r11 to r12 are included in the non-placement phase range is set as the phase distribution of the metalens 31. In the phase distribution 322, the phase range corresponding to the range of the distances r11 to r12 from the optical center C is the range of φ11′ to φ12′, and is included in the non-placement phase range.

### <Second Example Configuration of a Metalens>

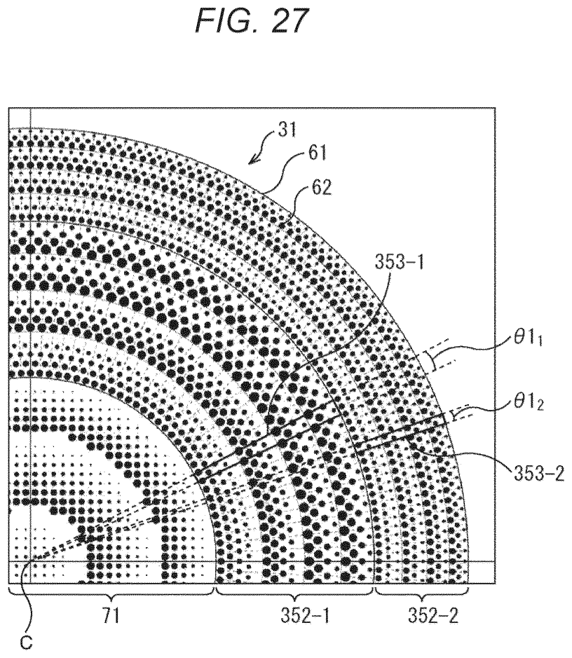

FIG. 27 is part of a top view of a metalens 31, illustrating a second example configuration of the metalens 31.

Note that, in the metalens 31 in FIG. 27, the portions corresponding to those of the metalens 31 in FIG. 3 are denoted by the same reference signs. Therefore, explanation of those portions is omitted herein as appropriate, and the different portions from those of the metalens 31 in FIG. 3 are mainly described. The number of the peripheral regions and the ratio of the center angle of each peripheral region of the metalens 31 in FIG. 27 are different from those of the metalens 31 in FIG. 3, and the other portions are similar to those of the metalens 31 in FIG. 3.

Specifically, on the outer side of the center region 71 of the metalens 31 in FIG. 27, annular peripheral regions 352-1 and 352-2 are disposed adjacent to each other in this order from the inner side. Note that, in the description below, in a case where there is no particular need to distinguish the peripheral regions 352-1 and 352-2 from each other, they will be collectively referred to as the peripheral regions 352.

In the peripheral regions 352, a plurality of pillars 62 is arranged in polar coordinates. Specifically, the peripheral region 352-1 is divided into N1₁ periodic regions 353-1 at each center angle θ1₁. The peripheral region 352-2 is divided into N1₂ periodic regions 353-2 at each center angle θ1₂. Note that, in the description below, in a case where there is no particular need to distinguish the periodic regions 353-1 and 353-2 from each other, they will be collectively referred to as the periodic regions 353.

In each periodic region 353, the pillars 62 are disposed on the basis of the position coordinates in the polar coordinate system, and the pattern of the pillars 62 disposed in each periodic region 353 is the same. The center angle θ1₁ of the peripheral region 352-1 is greater than the center angle θ1₂ of the peripheral region 352-2, and the ratio between the center angle θ1₁ and the center angle θ1₂ is an integer ratio. In the example in FIG. 27, the center angle θ1₁: the center angle θ1₂ is 2:1. That is, the center angle θ1₁ is twice the center angle θ1₂. In other words, the number N1₂ of the periodic regions 353-2 in the peripheral region 352-2 is twice the number N1₁ of the periodic regions 353-1 in the peripheral region 352-1. Although not illustrated in the drawing, the periodic regions 353 are divided into unit regions in a similar manner for the periodic regions 73 in FIG. 4, and the patterns of the pillars in a pair of adjacent unit regions basically have similarity.

As described above, the metalens 31 is designed so that the center angle θᵢ (θ11) of the peripheral region 72-i (352-1) is greater than the center angle θj (θ12) of the peripheral region 72-j (352-2). Accordingly, the layout of the pillars 62 can be prevented from becoming more sparse at a portion on an outer side in the peripheral regions 72 (352), and diffraction efficiency can be increased.

Also, in the metalens 31, when the ratio between the center angle θᵢ (θ11) and the center angle θᵢ₊₁ (θ1₂) is represented by an integer ratio Mₖ:Mₖ₊₁, Mₖ₊₁ is set to an integer smaller than 10. Accordingly, isotropy can be ensured even at the boundaries between the peripheral regions 72 (352). In the metalens 31, the patterns of the pillars 62 in a pair of adjacent unit regions 81 have similarity, and thus, the verification pattern for OPC can be prevented from becoming enormous.

In the metalens 31, the pillars 62 are arranged in orthogonal coordinates in the center region 71. Accordingly, designing can be easily performed by a library method. Furthermore, as compared with those in a case where the center region 71 is disposed in polar coordinates, the layout of the pillars 62 in the vicinity of the optical center C is not complicated, and the manufacture control by OPC is easier.

### <Detailed Description of Patterns of Pillars in a Periodic Region>

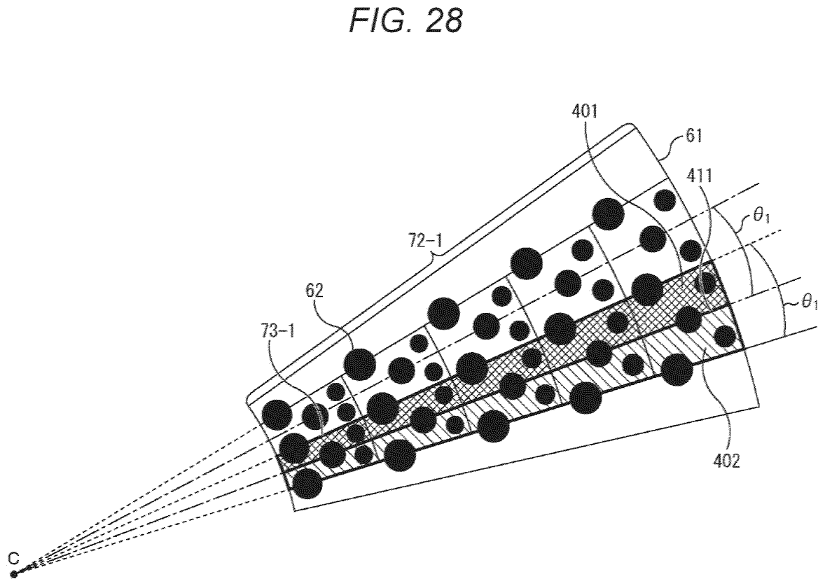

FIGS. 28 to 30 are diagrams illustrating details of patterns of the pillars in a periodic region 73-1 of the metalens 31.

As illustrated in FIG. 28, each periodic region 73-1 of the metalens 31 is divided into two regions 401 and 402 having a center angle θ₁/2. The pattern of the pillars 62 disposed in the region 401 and the pattern of the pillars 62 disposed in the region 402 are symmetric about the boundary 411 between the region 401 and the region 402. That is, each periodic region 73-1 has the boundary 411 as the symmetry axis of the pattern of the pillars 62. In the peripheral region 72-1, the boundaries 411 of the respective periodic regions 73 periodically exist at angular intervals of the center angle θ₁.

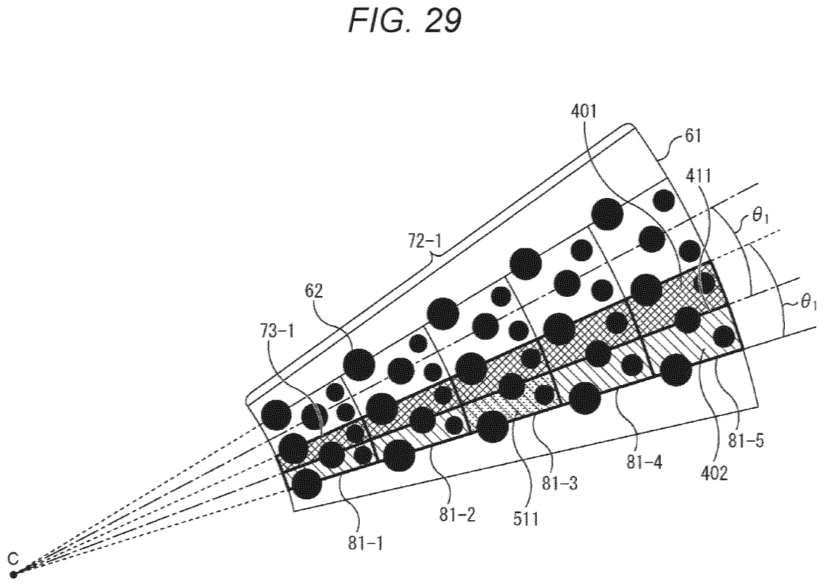

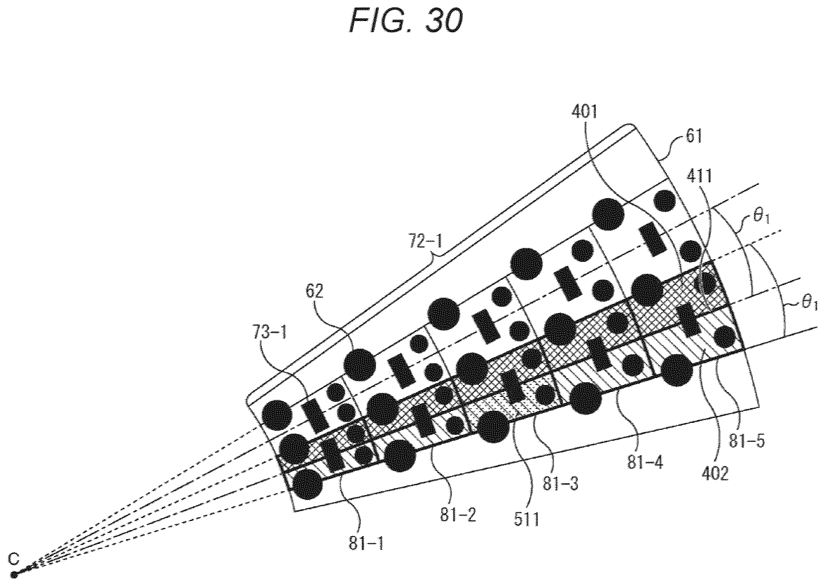

As illustrated in FIGS. 29 and 30, the periodic region 73-1 is also divided into unit regions 81. In the examples in FIGS. 29 and 30, each periodic region 73-1 is divided into five unit regions 81-1 to 81-5.

In the example in FIG. 29, all the pillars 62 disposed in a symmetrical unit region 511, which is a region included in either the region 401 or the region 402 in each unit region 81, have a columnar shape, and the number of columnar pillars 62 is three. In the example in FIG. 30, the types of the shapes of the three pillars 62 disposed in the symmetrical unit region 511 are a columnar type and a rectangular parallelepiped type, the number of the columnar pillars 62 is two, and the number of the rectangular parallelepiped pillars 62 is one.

Note that, although not illustrated in the drawing, symmetry axes are provided not only in the periodic regions 73-1 but also in the other periodic regions 73-2 and 73-3.

As described above, the patterns of the pillars 62 disposed in both the region 401 and the region 402 are symmetric about the boundary 411. With this arrangement, in the metalens 31, the magnitudes and the signs of the components in the radial direction of the metalens 31 among wave number vectors are the same, and equal optical responses can be achieved in response to incident light rays having components of the same magnitude but of different signs in the circumferential direction.

### <Example of the External Configuration of a Pillar>

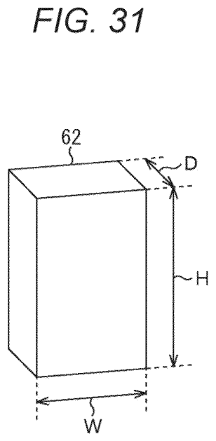

FIG. 31 is a perspective view illustrating an example of the external configuration of a rectangular parallelepiped pillar 62 in FIG. 30.

The width W and the depth D of the rectangular parallelepiped pillar 62 in FIG. 31 are 100 to 300 nm, for example, and the height H is 600 nm, for example.

### Second Embodiment

### <Example of Patterns in Periodic Regions>

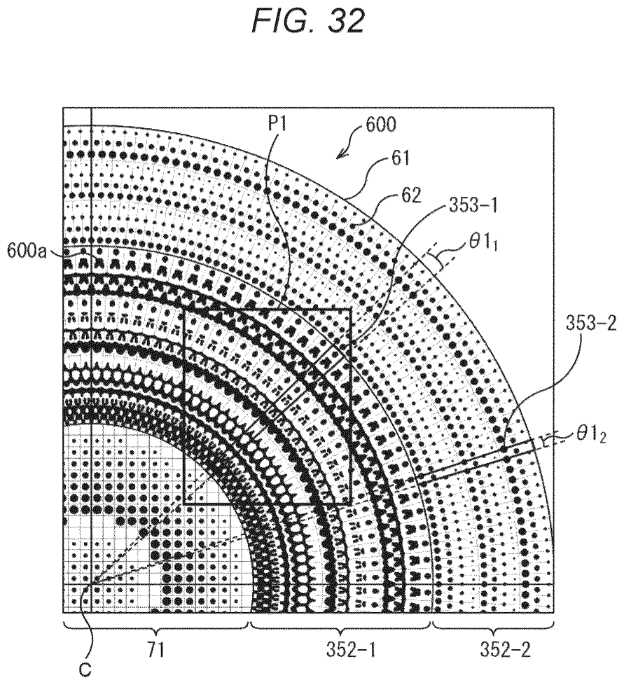

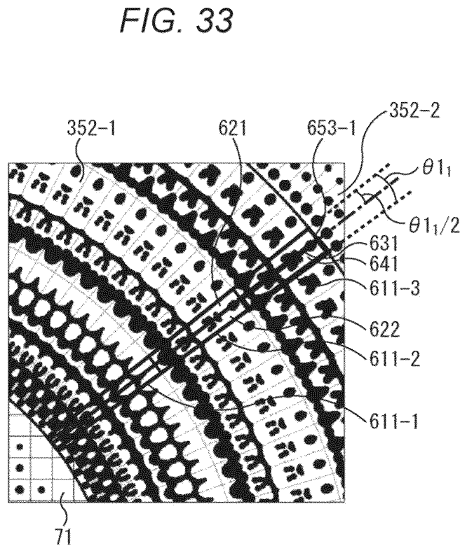

FIG. 32 is part of a top view of a metalens, illustrating an example of patterns in periodic regions in a second embodiment of a metalens to which the present technology is applied. FIG. 33 is an enlarged view of a rectangle P1 shown in FIG. 32.

Note that, in a metalens 600 in FIG. 32, the portions corresponding to those of the metalens 31 in FIG. 27 are denoted by the same reference signs. Therefore, explanation of those portions is omitted herein as appropriate, and the different portions from those of the metalens 31 in FIG. 27 are mainly described. The metalens 600 in FIG. 32 differs from the metalens 31 in FIG. 27 in that free-form patterns 600a (structures) are disposed, instead of the pillars 62, in a periodic region 353-1, and the other components are similar to those of the metalens 31 in FIG. 27.

Specifically, as illustrated in FIG. 33, a periodic region 353-1 of the metalens 600 is divided into three unit regions 611-1 to 611-p, as in the metalens 31. In FIG. 33, p is set to three to simplify the drawing, but p is not limited to this. Note that, in the description below, in a case where there is no particular need to distinguish the unit regions 611-1 to 611-p from one another, they will be collectively referred to as the unit regions 611.

Each periodic region 353-1 is divided into two regions 621 and 622 having a center angle θ1₁/2. The patterns 600a arranged in the region 621 and the patterns 600a arranged in the region 622 are symmetric about the boundary 631 between the region 621 and the region 622. That is, each periodic region 353-1 has the boundary 631 as the symmetry axis of the patterns 600a. In the peripheral region 352-1, the boundaries 631 of the respective periodic regions 353-1 periodically exist at angular intervals of the center angle θ1₁. The patterns 600a are free-form structures having functions similar to those of the pillars 62.

Note that symmetry axes are provided not only in the periodic regions 353-1 but also in the periodic regions 353-2. In the periodic regions 353-2, the patterns 600a may be disposed, instead of the pillars 62.

The design of the metalens 600 in which the patterns 600a are arranged as described above can be realized by performing topology optimization and shape optimization for each unit region 611. In the metalens 600, the free-form patterns 600a are disposed, so that the degree of freedom in the shape of the structures having phases to be modulated is higher than that in a case where the pillars 62 having a shape that can be expressed only as a simple figure are adopted. Accordingly, optical characteristics closer to desired optical characteristics can be achieved.

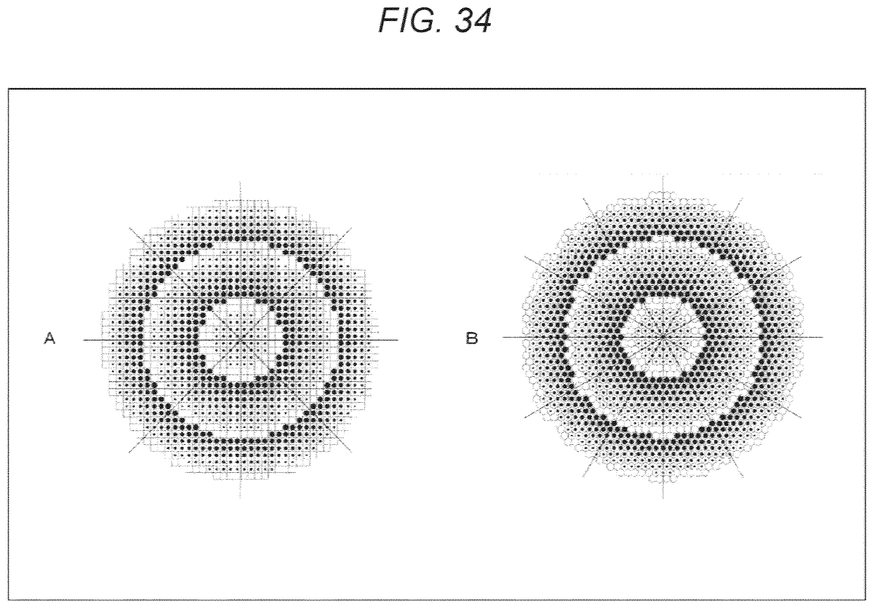

In the first and second embodiments described above, the pillars 62 are arranged in orthogonal coordinates in the center region 71. However, some other patterns having symmetry equal to or more ideal than a pattern formed with pillars arranged in orthogonal coordinates may be used. A of FIG. 34 is an example of a center region having a pattern formed with pillars arranged on a square lattice. In this case, the pattern in the center region has four symmetry axes. B of FIG. 34 is an example of a center region having a pattern formed with pillars arranged on a regular hexagonal lattice. In this case, the pattern in the center region has six symmetry axes.

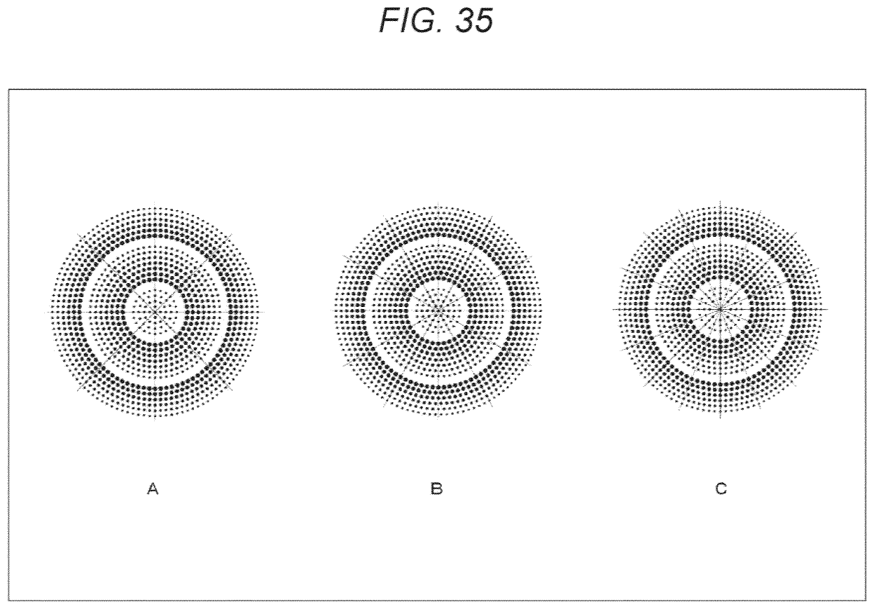

A of FIG. 35 is an example of a center region that has a pattern formed with pillars, the pattern having four symmetry axes (the pillars not being arranged on a square lattice). B of FIG. 35 is an example of a center region that has a pattern formed with pillars, the pattern having six symmetry axes (the pillars not being arranged on a regular hexagonal lattice). C of FIG. 35 is an example of a center region having a pattern formed with pillars, the pattern having eight symmetry axes.

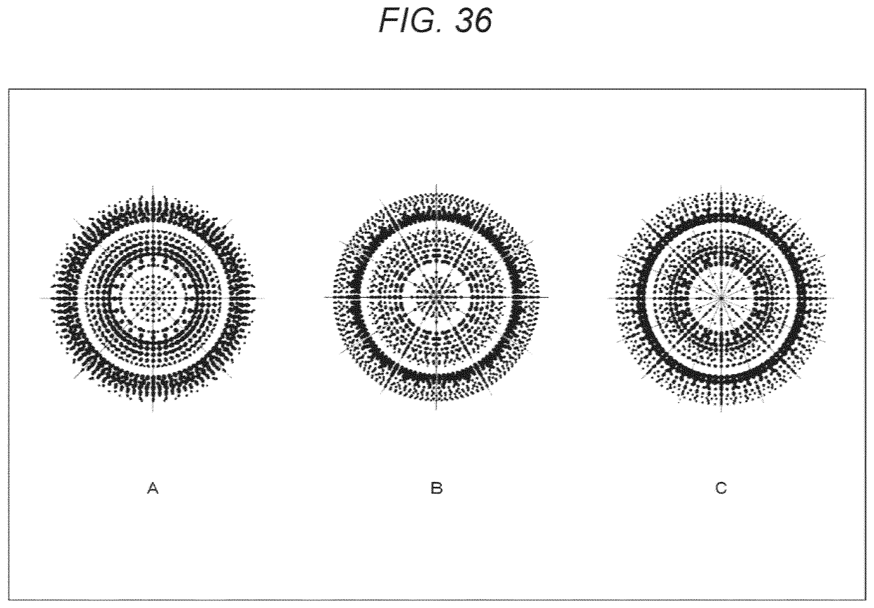

A of FIG. 36 is an example of a center region having a free-form pattern that has four symmetry axes. B of FIG. 36 is an example of a center region having a free-form pattern that has six symmetry axes. C of FIG. 36 is an example of a center region having a free-form pattern that has eight symmetry axes.

As described above, even in a pattern that is not a pattern arranged on a square lattice or a regular hexagonal lattice, by providing four or more symmetry axes, it is possible to achieve optical characteristics having isotropy equal to or better than that of a pattern arranged on a square lattice or a regular hexagonal lattice (for example, the isotropy is equal to that of a pattern arranged on a square lattice when the number of symmetry axes is four, the isotropy is better than that of a pattern arranged on a square lattice and is equal to that of a pattern arranged on a regular hexagonal lattice when the number of symmetry axes is six, and the isotropy is better than that of a pattern arranged on a square lattice and that of a pattern arranged on a regular hexagonal lattice when the number of symmetry axes is larger than six).

Further, when there are n symmetry axes, the patterns in other center regions are uniquely determined in accordance with the pattern in one fan-like region among fan-like regions obtained by dividing the entire center region into 2×n parts. Therefore, only the patterns in the fan-like regions are to be designed. By providing symmetry axes, the design regions can be reduced, which leads to decreases in calculation cost and design data at the time of designing. The number of the peripheral regions 72 is not limited to the above-mentioned numbers, but may be any appropriate number.

As described above, in a metalens 31 (600) to which the present technology is applied, diffraction efficiency is increased. Therefore, the lens system 22 on the light receiving side of the distance measuring device 10 is formed with the metalens 31 (600) to which the present technology is applied, so that the signal/noise (SN) ratio in distance measurement can be improved. Furthermore, the lens system 41 on the light projecting side of the distance measuring device 10 is formed with the metalens 31 (600) to which the present technology is applied, so that the instability of operation of the VCSEL 14 due to return light and a decrease in irradiation power can be reduced.

The present technology may be applied to both the lens system 22 on the light receiving side and the lens system 41 on the light projecting side of the distance measuring device 10, or may be applied to only one of the two lens systems.

The metalens 31 (600) to which the present technology is applied can be used not only in a distance measuring device but also in a device including other lenses as components. For example, the metalens 31 (600) to which the present technology is applied can be used in place of an existing bulk lens in an interchangeable lens of a camera, a camera module of a mobile device, or a lens system of an augmented reality (AR) device, a virtual reality (VR) device, or the like. As the metalens 31 (600) to which the present technology is applied is used in these lens systems, it is possible to realize enlargement of the FoV, a decrease in the f-number (an increase in brightness), an increase in contrast, miniaturization (a decrease in height), a decrease in weight of each lens system, and the like.

The metalens 31 (600) to which the present technology is applied can also be applied to a DOE lens for chromatic aberration correction. As the metalens 31 (600) to which the present technology is applied is used for a DOE lens for chromatic aberration correction, the DOE lens can perform more intense chromatic aberration correction. As a result, the image quality of an image captured with the DOE lens for chromatic aberration correction is enhanced. Embodiments of the present technology are not limited to the embodiments described above, and various modifications can be made to them without departing from the scope of the present technology.

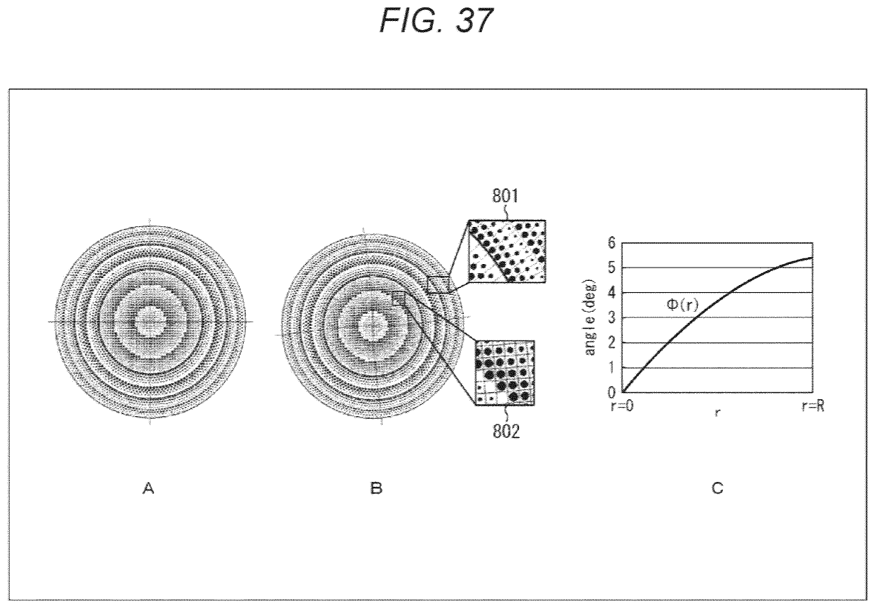

For example, the above-described embodiments include a metalens in which a region in the vicinity of the boundary between a center region and a peripheral region is within a non-placement region in which no pillars are disposed, and the patterns in the respective peripheral regions have symmetry axes, as illustrated in A of FIG. 37. However, a metalens in B of FIG. 37 may be a metalens in which the metalens in A of FIG. 37 is deformed by an angle Φ(r) counterclockwise in a circumferential direction. Here, r represents the distance from the optical center, and Φ(r) represents a function that depends only on the distance r as illustrated in C of FIG. 35. As illustrated in enlarged views 801 and 802, the metalens in B of FIG. 37 also locally has a configuration similar to those of the above-described embodiments, and may have similar properties. It is safe to say that the metalens in B of FIG. 35 is “a metalens that has a configuration similar to those of the above embodiments when the patterns are deformed clockwise by an angle Φ(r) along the circumference”.

For example, it is possible to adopt a mode obtained by combining all or some of the plurality of embodiments described above.

Note that, the effects described in the present specification are merely examples and are not restrictive, and there may be effects other than those described in the present specification.

The present technology can have the following configurations.

(1)

A lens including:
a center region located in a central portion; and
a plurality of ring-shaped peripheral regions located around the center region, in which a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and
the Mₖ₊₁ is an integer smaller than 10.
   (2)

The lens according to (1), in which
the Mₖ₊₁ is 1.
   (3)

The lens according to (1) or (2), in which
the pattern in the peripheral regions has a symmetry axis.
   (4)

The lens according to any one of (1) to (3), in which
the pattern in the peripheral regions includes pillars, and
a ratio of a total number of pairs in which both types of shape of the pillars and the numbers of the pillars in each shape are equal, to a total number of all pairs of adjacent unit regions in the peripheral regions is equal to or higher than 90%.
   (5)

The lens according to (4), in which
a ratio of a total number of pairs in which both the types of shape of the pillars and the numbers of the pillars in each shape are equal, and a similarity condition is satisfied, to the total number of all pairs of the adjacent unit regions in the peripheral regions is equal to or higher than 90%.
   (6)

The lens according to any one of (1) to (5), in which
a ratio of an inner circumferential length of a unit region in the peripheral regions to an outer circumferential length of the unit region in the peripheral regions is higher than 80%.
   (7)

The lens according to any one of (1) to (6), in which
a pattern in the center region has four or more symmetry axes.
   (8)

The lens according to (7), in which
the center region has a pattern that includes pillars.
   (9)

The lens according to (8), in which
the center region has a pattern that includes the pillars arranged on a square lattice or a regular hexagonal lattice.
   (10)

The lens according to (9), in which
a region near a boundary between the center region and the peripheral regions is in a non-placement region in which the pillars are not disposed.
   (11)

The lens according to any one of (1) to (10), in which,
when the pattern is deformed by an angle φ(r) in a circumferential direction, the pattern in the peripheral regions has a symmetry axis.
   (12)

The lens according to (1), in which
the center region has a circular shape.
   (13)

The lens according to (1), further including:
a substrate on which the center region and the peripheral regions are formed; and
an embedding layer that fills voids in the pattern.
   (14)

The lens according to (1), in which
the pattern includes pillars, and
a width of at least part of the pillars is not greater than 2000 nm.
   (15)

An imaging device including:
a lens including:
a center region located in a central portion; and
a plurality of ring-shaped peripheral regions located around the center region,
in which a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and
the Mₖ₊₁ is an integer smaller than 10; and
an imaging element that receives light via the lens.
   (16)

A light emitting device including:
a lens including:
a center region located in a central portion; and
a plurality of ring-shaped peripheral regions located around the center region,
in which a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and
the Mₖ₊₁ is an integer smaller than 10; and
a light emitting element that emits light that enters the lens.
   (17)

A lens including:
a first peripheral region that is an annular region centered around an optical center, and is divided into N1 first periodic regions at each center angle θ1;
a second peripheral region that is located on an outer side of the first peripheral region, is an annular region centered around the optical center, and is divided into N2 second periodic regions at each center angle θ2; and
a circular center region that is located on an inner side of the first peripheral region, and is centered around the optical center,
in which a pattern is provided in the first periodic regions and the second periodic regions, on the basis of position coordinates in a polar coordinate system,
the center angle θ1 is greater than the center angle θ2,
the center region has four or more central symmetry axes that are symmetry axes for the pattern,
the pattern in the center region is symmetric about the central symmetry axes, and
a layout of the pattern in the center region is an orthogonal coordinate layout.

Further, the present technology can also have the following configurations.

(1)

A lens including:
a first peripheral region that is an annular region centered around an optical center, and is divided into N1 first periodic regions at each center angle θ1; and
a second peripheral region that is located on an outer side of the first peripheral region, is an annular region centered around the optical center, and is divided into N2 second periodic regions at each center angle θ2,
in which patterns provided in the N1 respective first periodic regions are the same,
patterns provided in the N2 respective second periodic regions are the same,
the center angle θ1 is greater than the center angle θ2,
the first peripheral region and the second peripheral region are adjacent to each other, and
when a ratio between the center angle θ1 and the center angle θ2 is a:b, the b is an integer smaller than 10.
   (2)

The lens according to (1), in which
the a:b is 2:1.
   (3)

The lens according to (1), in which
the first periodic region has a first symmetry axis that is a symmetry axis of the pattern in the first periodic region, and
the pattern in the first periodic region is symmetric about the first symmetry axis,
the second periodic region has a second symmetry axis that is a symmetry axis of the pattern in the second periodic region, and
the pattern in the second periodic region is symmetric about the second symmetry axis.
   (4)

The lens according to (1), in which
the pattern includes pillars,
when each of the first periodic regions and the second periodic regions is divided for each unit region corresponding to a range in which a phase distribution of the lens changes by 2π, a configuration of the pillars in each unit region of a pair of adjacent unit regions has similarity, and
the configuration of the pillars includes the number of the pillars, and a position, a shape, and a size of each pillar.
   (5)

The lens according to (4), in which
a ratio of the number of pairs in which the types of shape of the pillars provided and the numbers of the pillars in each shape are equal, to a total number of the pairs is equal to or higher than 90%.
   (6)

The lens according to (5), in which
a ratio of the number of pairs in which types of shape of the pillars provided and the numbers of the pillars in each shape are equal, and a difference amount in the configuration of the pillars is smaller than a threshold, to the total number of the pairs is equal to or higher than 90%.
   (7)

The lens according to (1), in which,
when each of the first periodic regions and the second periodic regions is divided for each unit region corresponding to a range in which a phase distribution of the lens changes by 2π, a ratio of an inner circumferential length of the unit region to an outer circumferential length of the unit region is higher than 80%.
   (8)

The lens according to (1), further including
a center region that is located on an inner side of the first peripheral region, and has a circular shape centered around the optical center,
in which the center region has four or more central symmetry axes that are symmetry axes of a pattern, and
the pattern in the center region is symmetric about the central symmetry axes.
   (9)

The lens according to (8), in which
a layout of the pattern in the center region is an orthogonal coordinate layout.
   (10)

The lens according to (9), in which
a region near a boundary between the center region and the peripheral regions is in a non-placement region in which the pattern is not provided.
   (11)

The lens according to (1), further including:
a substrate on which the first peripheral region and the second peripheral region are formed; and
an embedding layer that fills voids in the patterns provided in the first peripheral region and the second peripheral region.
   (12)

The lens according to (1), in which
a size of the pattern on a surface of the substrate is smaller than both a wavelength of incident light in the substrate and a wavelength of the incident light in the embedding layer.
   (13)

An imaging device including:
a lens including:
a first peripheral region that is an annular region centered around an optical center, and is divided into N1 first periodic regions at each center angle θ1; and
a second peripheral region that is located on an outer side of the first peripheral region, is an annular region centered around the optical center, and is divided into N2 second periodic regions at each center angle θ2,
in which patterns provided in the N1 respective first periodic regions are the same,
patterns provided in the N2 respective second periodic regions are the same,
the center angle θ1 is greater than the center angle θ2,
the first peripheral region and the second peripheral region are adjacent to each other, and,
when a ratio between the center angle θ1 and the center angle θ2 is a:b, the b is an integer smaller than 10; and
an imaging element that receives light via the lens.
   (14)

A light emitting device including:
a lens including:
a first peripheral region that is an annular region centered around an optical center, and is divided into N1 first periodic regions at each center angle θ1; and
a second peripheral region that is located on an outer side of the first peripheral region, is an annular region centered around the optical center, and is divided into N2 second periodic regions at each center angle θ2,
in which patterns provided in the N1 respective first periodic regions are the same,
patterns provided in the N2 respective second periodic regions are the same,
the center angle θ1 is greater than the center angle θ2,
the first peripheral region and the second peripheral region are adjacent to each other, and,
when a ratio between the center angle θ1 and the center angle θ2 is a:b, the b is an integer smaller than 10; and
a light emitting element that emits light that enters the lens.

### REFERENCE SIGNS LIST

10 Distance measuring device
31, 51 Metalens
61 Substrate
62 Pillar
63 Embedding layer
71 Center region
72-1 to 72-3 Peripheral region
73-1 to 73-3 Periodic region
81-1 to 81-3 Unit region
302 Boundary
303 Lattice cell
352-1, 352-2 Peripheral region
353-1, 353-2 Periodic region
411 Boundary
600 Metalens
611-1 to 611-3 Unit region
631 Boundary

What is claimed is:

1. A lens, comprising:
a center region located in a central portion; and
a plurality of ring-shaped peripheral regions located around the center region,
wherein a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side among the peripheral regions, the (k+1)-th peripheral region being adjacent to the k-th peripheral region, and
the Mₖ₊₁ is an integer smaller than 10.

2. The lens according to claim 1, wherein
the Mₖ₊₁ is 1.

3. The lens according to claim 1, wherein
the pattern in the peripheral regions has a symmetry axis.

4. The lens according to claim 1, wherein
the pattern in the peripheral regions includes pillars, and
a ratio of a total number of pairs in which both types of shape of the pillars and the numbers of the pillars in each shape are equal, to a total number of all pairs of adjacent unit regions in the peripheral regions is equal to or higher than 90%.

5. The lens according to claim 4, wherein
a ratio of a total number of pairs in which both the types of shape of the pillars and the numbers of the pillars in each shape are equal, and a similarity condition is satisfied, to the total number of all pairs of the adjacent unit regions in the peripheral regions is equal to or higher than 90%.

6. The lens according to claim 1, wherein
a ratio of an inner circumferential length of a unit region in the peripheral regions to an outer circumferential length of the unit region in the peripheral regions is higher than 80%.

7. The lens according to claim 1, wherein
a pattern in the center region has four or more symmetry axes.

8. The lens according to claim 7, wherein
the center region has a pattern that includes pillars.

9. The lens according to claim 8, wherein
the center region has a pattern that includes the pillars arranged on one of a square lattice or a regular hexagonal lattice.

10. The lens according to claim 9, wherein
a region near a boundary between the center region and the peripheral regions is in a non-placement region in which the pillars are not disposed.

11. The lens according to claim 1, wherein,
when the pattern is deformed by an angle φ(r) in a circumferential direction, the pattern in the peripheral regions has a symmetry axis.

12. The lens according to claim 1, wherein
the center region has a circular shape.

13. The lens according to claim 1, further comprising:
a substrate on which the center region and the peripheral regions are formed; and
an embedding layer that fills a void in the pattern.

14. The lens according to claim 1, wherein
the pattern includes pillars, and
a width of at least part of the pillars is not greater than 2000 nm.

15. An imaging device, comprising:
a lens including:
a center region located in a central portion; and
a plurality of ring-shaped peripheral regions located around the center region,
wherein a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and
the Mₖ₊₁ is an integer smaller than 10; and
an imaging element that receives light via the lens.

16. A light emitting device, comprising:
a lens including:
a center region located in a central portion; and
a plurality of ring-shaped peripheral regions located around the center region,
wherein a pattern in the peripheral regions has constant intervals in an angular direction,
an angular interval Δθₖ:Δθₖ₊₁ is an integer ratio Mₖ:Mₖ₊₁, where Δθₖ represents an angular interval in a k-th peripheral region from an inner side among the peripheral regions, and Δθₖ₊₁ represents an angular interval in a (k+1)-th peripheral region from the inner side, the (k+1)-th peripheral region being adjacent to the k-th peripheral region, and
the Mₖ₊₁ is an integer smaller than 10; and
a light emitting element that emits light that enters the lens.

17. A lens, comprising:
a first peripheral region that is an annular region centered around an optical center, and is divided into N1 first periodic regions at each center angle θ1;
a second peripheral region that is located on an outer side of the first peripheral region, is an annular region centered around the optical center, and is divided into N2 second periodic regions at each center angle θ2; and
a circular center region that is located on an inner side of the first peripheral region, and is centered around the optical center,
wherein a pattern is provided in the first periodic regions and the second periodic regions, on a basis of position coordinates in a polar coordinate system,
the center angle θ1 is greater than the center angle θ2,
the center region has four or more central symmetry axes that are symmetry axes of the pattern,
the pattern in the center region is symmetric about the central symmetry axes, and
a layout of the pattern in the center region is an orthogonal coordinate layout.
